(19) United States
(12) Patent Application Publication
(10) Pub. No.: US 2013/0182770 A1
(43) Pub. Date: Jul. 18, 2013

(54) IMAGE PROCESSING DEVICE, AND IMAGE PROCESSING METHOD

(71) Applicant: Kenji Kondo, Tokyo (JP)

(72) Inventor: Kenji Kondo, Tokyo (JP)

(73) Assignee: SONY CORPORATION, Tokyo (JP)

(21) Appl. No.: 13/824,839

(22) PCT Filed: Oct. 17, 2011
(86) PCT No.: PCT/JP2011/073810

§ 371 Date: Mar. 18, 2013

(30) Foreign Application Priority Data
Nov. 8, 2010 (JP) 2010250031

(51) Int. Cl. H04N 7/26

(52) U.S. Cl. CPC H04N 19/00696
USPC 375/240.16

(57) ABSTRACT

Deterioration in the quality of predicted images is to be reduced so as to restrain decreases in compression efficiency. When a motion prediction/compensation unit 32 generates predicted image data by performing motion compensation with the use of reference image data, based on a motion vector detected through motion detection, the filter characteristics of an interpolation filter that determines image data with fractional pixel precision of the reference image data of the current block are changed in accordance with the size of the motion vector. As a result, the filter characteristics are changed to characteristics for performing denoising when the motion size is large, and to characteristics for not performing filtering operations when a large amount of high-pass components is contained in the reference image, such as when the motion vector has integer pixel precision, the motion size is small, and motion blurring does not often occur. Thus, decreases in compression efficiency due to deterioration in the quality of predicted images can be restrained.

### TECHNICAL FIELD

This technique relates to image processing devices and image processing methods. More particularly, this technique is to reduce deterioration in the quality of predicted images and restrain decreases in compression efficiency.

### BACKGROUND ART

In recent years, apparatuses that handle image information as digital information and achieve high-efficiency information transmission and accumulation in doing so, or apparatuses compliant with a standard such as MPEG for compression through orthogonal transforms like discrete cosine transforms and motion compensations, have been spreading among broadcast stations and general households.

Particularly, MPEG2 (ISO/IEC 13818-2) is defined as a general-purpose image encoding standard, and is currently used for a wide range of applications for professionals and general consumers. According to the MPEG2 compression standard, a bit rate of 4 to 8 Mbps is assigned to an interlaced image having a standard resolution of 720×480 pixels, for example. In this manner, high compression rates and excellent image quality can be realized. Also, a bit rate of 18 to 22 Mbps is assigned to a high-resolution interlaced image having 1920×1088 pixels, so as to realize high compression rates and excellent image quality.

Although a larger amount of calculation than that of a conventional encoding method such as MPEG2 or MPEG4 is required in encoding and decoding, standardization to realize higher encoding efficiency was conducted under the name of Joint Model of Enhanced-Compression Video Coding, which has become international standards as H.264 and MPEG-4 Part 10 (hereinafter referred to as “H.264/AVC (Advanced Video Coding)”).

In H.264/AVC, a macroblock formed with 16×16 pixels is divided into 16×16, 16×8, 8×16, or 8×8 pixel regions that can have motion vectors independently of one another, as shown in FIG. 1. Further, as shown in FIG. 1, an 8×8 pixel region is divided into 8×8, 8×4, 4×8, or 4×4 pixel regions that can have motion vectors independently of one another. In MPEG-2, each unit in motion prediction/compensation operations is 16×16 pixels in a frame motion compensation mode, and is 16×8 pixels in each of a first field and a second field in a field motion compensation mode. With such units, motion prediction/compensation operations are performed.

Further, in H.264/AVC, as disclosed in Patent Document 1, motion prediction/compensation operations with fractional pixel precision such as ¼ pixel precision are performed. FIG. 2 is a diagram for explaining a motion prediction/compensation operation with ¼ pixel precision. In FIG. 2, position “A” represents the location of each integer precision pixel stored in the frame memory, positions “b”, “c”, and “d” represent the locations with ½ pixel precision, positions “e1”, “e2”, and “e3” represent the locations with ¼ pixel precision.

In the following, Clip1( ) is defined as shown in the equation (1):

$$\begin{matrix}[ Mathematical Formula 1 ] & \\ Clip 1 ( a ) = \{ \begin{matrix}0 ; if ( a < 0 ) \\ a ; otherwise \\ max\_pix ; if ( a > max\_pix )\end{matrix} & ( 1 )\end{matrix}$$

In the equation (1), the value of max_pix is 255 when an input image has 8-bit precision.

The pixel values at the locations “b” and “d” are generated by using a 6-tap FIR filter as shown in the equations (2) and (3):

F=A₋₂−5·A₋₁+20·A₀+20·A₁−5·A₂+A₃ (2)

b,d=Clip1((F+16)>>5) (3)

The pixel value at the location “c” is generated by using a 6-tap FIR filter as shown in the equation (4) or (5) and the equation (6):

F=b₋₂−5·b₋₁+20·b₀+20·b₁−5·b₂+b₃ (4)

F=d₋₂−5·d₋₁+20·d₀+20·d₁−5·d₂+d₃ (5)

c=Clip1((F+512)>>10) (6)

The Clip1 processing is performed only once at last, after product-sum operations are performed both in the horizontal direction and the vertical direction.

The pixel values at the locations “e1” through “e3” are generated by linear interpolations as shown in the equations (7) through (9):

e1=(A+b+1)>>1 (7)

e2=(b+d+1)>>1 (8)

e3=(b+c+1)>>1 (9)

In the field of image compression, standardization of HEVC (High Efficiency Video Coding) to realize higher encoding efficiency than H.264/AVC is being considered. In HEVC, basic units called coding units (CUs) that extend the concept of macroblocks are defined. Also, Non-Patent Document 1 suggests image compression in block sizes extended from 16×16 pixel macroblocks. In HEVC, prediction units (PUs) as basic units for predictions are also defined by dividing coding units.

### CITATION LIST

### Patent Document

Patent Document 1: Japanese Patent Application Laid-Open No. 2010-016453

### Non-Patent Document

Non-Patent Document 1: “Video Coding Using Extended Block Sizes” (Study Group 16, Contribution 123, ITU, COM16-C123-E, January 2009)

### SUMMARY OF THE INVENTION

### Problems to be Solved by the Invention

When predicted image data is generated by performing motion compensation with the use of reference image data, based on a motion vector detected through a motion prediction, a filtering operation is performed so as to remove noise. However, if the reference image data contains a large amount of high-pass components, or if motion size and motion blurring are small, there is a possibility that the high-pass components are lost during the filtering operation, resulting in deterioration in the quality of predicted images and a decrease in compression efficiency.

In view of the above, this technique aims to provide an image processing device and an image processing method that can reduce deterioration in the quality of predicted images, and restrain decreases in compression efficiency.

### Solutions to Problems

A first aspect of this technique is an image processing device that includes: an interpolation filtering unit that determines image data with fractional pixel precision of the reference image data of a current block; a filter control unit that changes the filter characteristics of the interpolation filtering unit in accordance with the size of the motion vector of the current block; and a motion compensation processing unit that performs motion compensation by using the image data determined by the interpolation filtering unit, and generates predicted image data based on the motion vector.

According to this technique, in an image processing device such as an image encoding device that divides input image data into pixel blocks, performs prediction operations on the respective pixel blocks with the use of reference image data, and encodes the difference between the input image data and the predicted image data, or an image decoding device that performs a decoding operation on compressed image information generated by an image encoding device, the filter characteristics of an interpolation filtering unit that determines image data with fractional pixel precision of the reference image data of a current block to be encoded or decoded are changed in accordance with the size of the motion vector obtained through motion detection performed on the current block with the use of the reference image data. When the motion vector has integer pixel precision and is larger than a threshold value, the filter characteristics are changed to such characteristics as to remove noise from the reference image data. When the motion vector has integer pixel precision and is equal to or smaller than the threshold value, the filter characteristics are changed to such characteristics as to perform no filtering operations. For example, for reference image data in which the motion size is zero, the threshold value is set to zero, so that filtering operations are not performed. Alternatively, the threshold value may be adaptively changed in accordance with the distance in the temporal direction between the frame for generating predicted image data and the frame of the reference image data to be used for motion compensation.

A second aspect of this technique is an image processing method that includes: an interpolation filtering step of determining image data with fractional pixel precision of the reference image data of a current block; a filter controlling step of changing filter characteristics of the interpolation filtering step in accordance with the size of the motion vector of the current block; and a motion compensation processing step of performing motion compensation by using the image data determined in the interpolation filtering step, and generating predicted image data based on the motion vector.

### Effects of the Invention

According to this technique, image data with fractional pixel precision of the reference image data of a current block is determined by an interpolation filtering unit. The filter characteristics of the interpolation filtering unit are changed in accordance with the size of the motion vector of the current block. Further, based on the motion vector, motion compensation is performed by using the image data determined by the interpolation filtering unit, and predicted image data is generated. Accordingly, when the reference image data contains a large amount of high-pass components, or when motion size and motion blurring are small, for example, the filter characteristics are changed so as not to perform any filtering operation, and decreases in compression coefficient due to deterioration in the quality of predicted images can be restrained.

### BRIEF DESCRIPTION OF DRAWINGS

FIG. 1 is a diagram showing block sizes in H.264/AVC.

FIG. 2 is a diagram for explaining a motion prediction/compensation operation with ¼ pixel precision.

FIG. 3 is a diagram illustrating the structure of an image encoding device.

FIG. 4 is a diagram showing the structure of the motion prediction/compensation unit.

FIG. 5 is a diagram showing the structure of the portion that performs filter control in the compensation control unit.

FIG. 6 is a diagram showing the filter characteristics achieved where a first filter coefficient is used, and the filter characteristics achieved where a second filter coefficient is used.

FIG. 7 show a hierarchical structure where macroblock sizes are extended.

FIG. 8 is a flowchart showing operations of the image encoding device.

FIG. 9 is a flowchart showing prediction operations.

FIG. 10 is a flowchart showing intra prediction operations.

FIG. 11 is a flowchart showing inter prediction operations.

FIG. 12 is a flowchart showing a motion compensation operation.

FIG. 13 is a diagram showing the structure of an image decoding device.

FIG. 14 is a diagram showing the structure of the motion compensation unit.

FIG. 15 is a flowchart showing operations of the image decoding device.

FIG. 16 is a flowchart showing a predicted image generating operation.

FIG. 17 is a flowchart showing an inter-predicted image generating operation.

FIG. 18 is a diagram schematically showing an example structure of a computer device.

FIG. 19 is a diagram schematically showing an example structure of a television apparatus.

FIG. 20 is a diagram schematically showing an example structure of a portable telephone device.

FIG. 21 is a diagram schematically showing an example structure of a recording/reproducing apparatus.

FIG. 22 is a diagram schematically showing an example structure of an imaging apparatus.

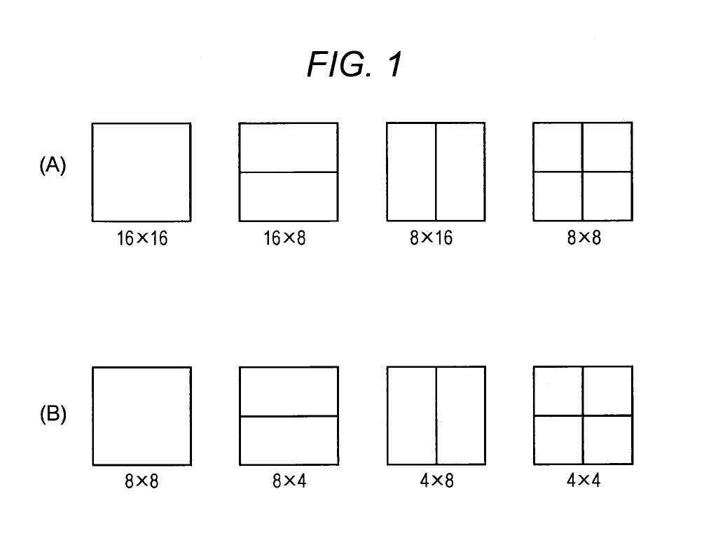

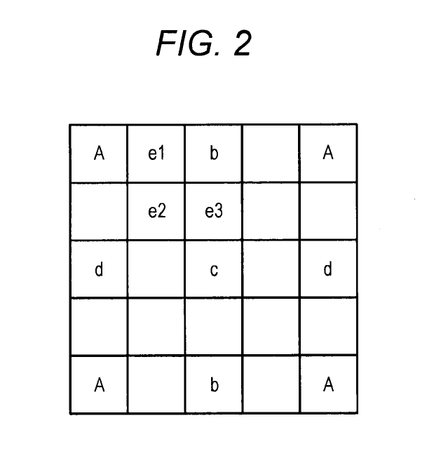

### MODE FOR CARRYING OUT THE INVENTION

The following is a description of embodiments for carrying out this technique. Explanation will be made in the following order.
1. Structure of an Image Encoding Device
2. Operations of the Image Encoding Device
3. Structure of an Image Decoding Device
4. Operations of the Image Decoding Device
5. Software Processing
6. Applications to Electronic Apparatuses

### [1. Structure of an Image Encoding Device]

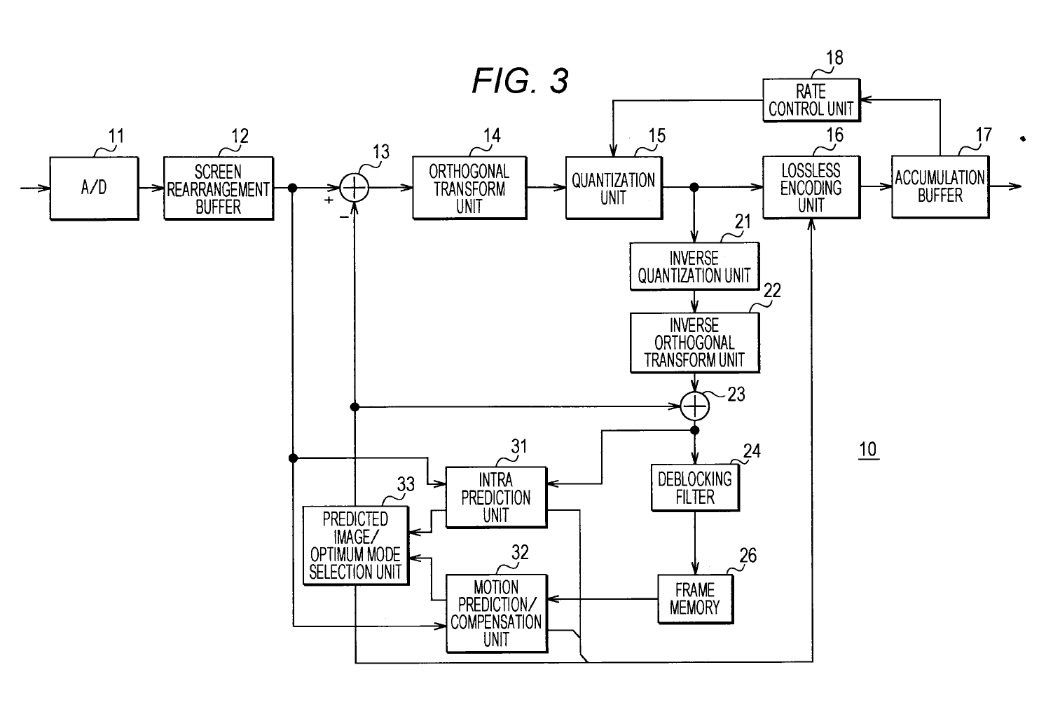

FIG. 3 shows a structure in which an image processing device is applied to an image encoding device. The image encoding device 10 includes an analog/digital converter (an A/D converter) 11, a screen rearrangement buffer 12, a subtraction unit 13, an orthogonal transform unit 14, a quantization unit 15, a lossless encoding unit 16, an accumulation buffer 17, and a rate control unit 18. The image encoding device 10 further includes an inverse quantization unit 21, an inverse orthogonal transform unit 22, an addition unit 23, a deblocking filter 24, a frame memory 26, an intra prediction unit 31, a motion prediction/compensation unit 32, and a predicted image/optimum mode selection unit 33.

The A/D converter 11 converts analog image signals into digital image data, and outputs the image data to the screen rearrangement buffer 12.

The screen rearrangement buffer 12 rearranges the frames of the image data output from the A/D converter 11. The screen rearrangement buffer 12 rearranges the frames in accordance with the GOP (Group of Pictures) structure related to encoding operations, and outputs the rearranged image data to the subtraction unit 13, the intra prediction unit 31, and the motion prediction/compensation unit 32.

The subtraction unit 13 receives the image data output from the screen rearrangement buffer 12 and predicted image data selected by the later described predicted image/optimum mode selection unit 33. The subtraction unit 13 calculates prediction error data that is the difference between the image data output from the screen rearrangement buffer 12 and the predicted image data supplied from the predicted image/optimum mode selection unit 33, and outputs the prediction error data to the orthogonal transform unit 14.

The orthogonal transform unit 14 performs an orthogonal transform operation, such as a discrete cosine transform (DCT) or a Karhunen-Loeve transform, on the prediction error data output from the subtraction unit 13. The orthogonal transform unit 14 outputs transform coefficient data obtained by performing the orthogonal transform operation to the quantization unit 15.

The quantization unit 15 receives the transform coefficient data output from the orthogonal transform unit 14 and a rate control signal supplied from the later described rate control unit 18. The quantization unit 15 quantizes the transform coefficient data, and outputs the quantized data to the lossless encoding unit 16 and the inverse quantization unit 21. Based on the rate control signal supplied from the rate control unit 18, the quantization unit 15 switches quantization parameters (quantization scales), to change the bit rate of the quantized data.

The lossless encoding unit 16 receives the quantized data output from the quantization unit 15, prediction mode information supplied from the later described intra prediction unit 31, and prediction mode information, a difference motion vector, and the like supplied from the motion prediction/compensation unit 32. Also, information indicating whether an optimum mode is an intra prediction or an inter prediction is supplied from the predicted image/optimum mode selection unit 33. The prediction mode information contains information indicating a prediction mode, block size information about the motion prediction unit, and the like, in accordance with whether the prediction mode is an intra prediction or an inter prediction. The lossless encoding unit 16 performs a lossless encoding operation on the quantized data through variable-length encoding or arithmetic encoding or the like, to generate and output compressed image information to the accumulation buffer 17. When the optimum mode is an intra prediction, the lossless encoding unit 16 performs lossless encoding on the prediction mode information supplied from the intra prediction unit 31. When the optimum mode is an inter prediction, the lossless encoding unit 16 performs lossless encoding on the prediction mode information, the difference motion vector, and the like supplied from the motion prediction/compensation unit 32. Further, the lossless encoding unit 16 incorporates the information subjected to the lossless encoding into the compressed image information. For example, the lossless encoding unit 16 adds the information to the header information in an encoded stream that is the compressed image information.

The accumulation buffer 17 stores the compressed image information supplied from the lossless encoding unit 16. The accumulation buffer 17 also outputs the stored compressed image information at a transmission rate suitable for the transmission path.

The rate control unit 18 monitors the free space in the accumulation buffer 17, generates a rate control signal in accordance with the free space, and outputs the rate control signal to the quantization unit 15. The rate control unit 18 obtains information indicating the free space from the accumulation buffer 17, for example. When the remaining free space is small, the rate control unit 18 lowers the bit rate of the quantized data through the rate control signal. When the remaining free space in the accumulation buffer 17 is sufficiently large, the rate control unit 18 increases the bit rate of the quantized data through the rate control signal.

The inverse quantization unit 21 inversely quantizes the quantized data supplied from the quantization unit 15. The inverse quantization unit 21 outputs the transform coefficient data obtained by performing the inverse quantization operation to the inverse orthogonal transform unit 22.

The inverse orthogonal transform unit 22 performs an inverse orthogonal transform operation on the transform coefficient data supplied from the inverse quantization unit 21, and outputs the resultant data to the addition unit 23.

The addition unit 23 adds the data supplied from the inverse orthogonal transform unit 22 to the predicted image data supplied from predicted image/optimum mode selection unit 33, to generate decoded image data. The addition unit 23 then outputs the decoded image data to the deblocking filter 24 and the intra prediction unit 31. The decoded image data is used as the image data of a reference image.

The deblocking filter 24 performs a filtering operation to reduce block distortions that occur at the time of image encoding. The deblocking filter 24 performs a filtering operation to remove block distortions from the decoded image data supplied from the addition unit 23, and outputs the filtered decoded image data to the frame memory 26.

The frame memory 26 stores the decoded image data that has been subjected to the filtering operation and is supplied from the deblocking filter 24. The decoded image data stored in the frame memory 26 is supplied as reference image data to the motion prediction/compensation unit 32.

Using the input image data of an encoding target image supplied from the screen rearrangement buffer 12 and the reference image data supplied from the addition unit 23, the intra prediction unit 31 performs predictions in all candidate intra prediction modes, to determine an optimum intra prediction mode. The intra prediction unit 31 calculates a cost function value in each of the intra prediction modes, for example, and sets the optimum intra prediction mode that is the intra prediction mode with the highest encoding efficiency, based on the calculated cost function values. The intra prediction unit 31 outputs the predicted image data generated in the optimum intra prediction mode and the cost function value in the optimum intra prediction mode to the predicted image/optimum mode selection unit 33. The intra prediction unit 31 further outputs prediction mode information indicating the optimum intra prediction mode to the lossless encoding unit 16.

Using the input image data of the encoding target image supplied from the screen rearrangement buffer 12 and the reference image data supplied from the frame memory 26, the motion prediction/compensation unit 32 performs predictions in all candidate inter prediction modes, to determine an optimum inter prediction mode. The motion prediction/compensation unit 32 calculates a cost function value in each of the inter prediction modes, for example, and sets the optimum inter prediction mode that is the inter prediction mode with the highest encoding efficiency, based on the calculated cost function values. The motion prediction/compensation unit 32 outputs the predicted image data generated in the optimum inter prediction mode and the cost function value in the optimum inter prediction mode to the predicted image/optimum mode selection unit 33. The motion prediction/compensation unit 32 further outputs prediction mode information about the optimum inter prediction mode to the lossless encoding unit 16.

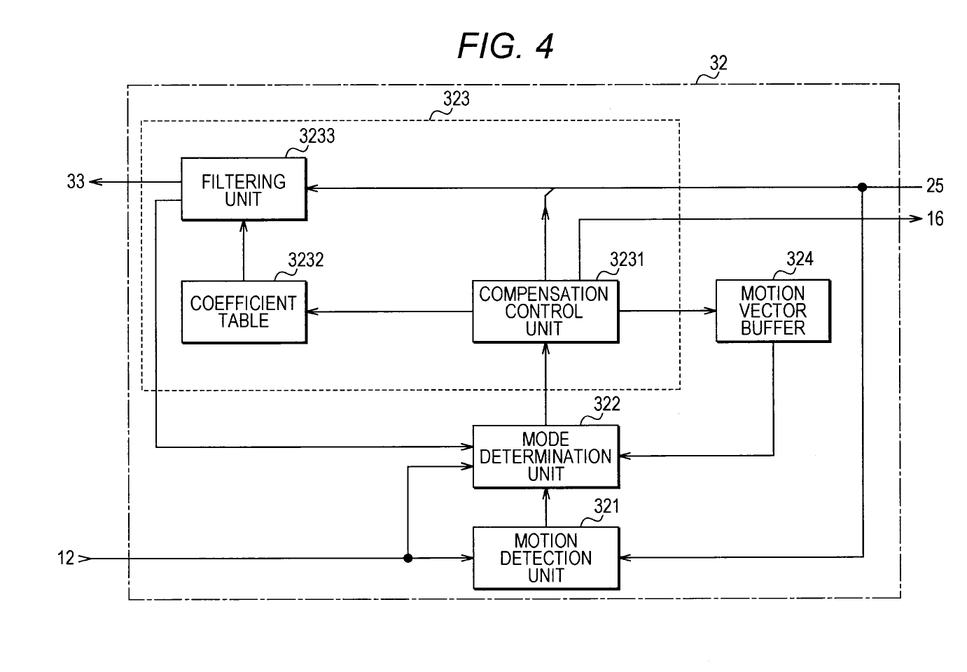

FIG. 4 shows the structure of the motion prediction/compensation unit 32. The motion prediction/compensation unit 32 includes a motion detection unit 321, a mode determination unit 322, a motion compensation processing unit 323, and a motion vector buffer 324.

Rearranged input image data supplied from the screen rearrangement buffer 12, and reference image data read from the frame memory 26 are supplied to the motion detection unit 321. The motion detection unit 321 conducts motion searches in all the candidate inter prediction modes, to detect a motion vector. The motion detection unit 321 outputs the motion vector indicating the detected motion vector, together with the input image data and reference image data for a case where a motion vector has been detected, to the mode determination unit 322.

The mode determination unit 322 receives the motion vector and the input image data from the motion detection unit 321, the predicted image data from the motion compensation processing unit 323, and the motion vector of an adjacent prediction unit from the motion vector buffer 324. Using the motion vector of the adjacent prediction unit, the mode determination unit 322 performs a median prediction or the like to set a predicted motion vector, and calculates a difference motion vector indicating the difference between the motion vector detected by the motion detection unit 321 and the predicted motion vector. Using the difference motion vector between the input image data and the predicted image data, the mode determination unit 322 calculates cost function values in all the candidate inter prediction modes. The mode determination unit 322 determines the mode with the smallest calculated cost function value to be the optimum inter prediction mode. The mode determination unit 322 further outputs the prediction mode information indicating the determined optimum inter prediction mode and the cost function value, as well as the motion vector and the difference motion vector and the like related to the optimum inter prediction mode, to the motion compensation processing unit 323. The mode determination unit 322 also outputs the prediction mode information and motion vector related to the inter prediction modes to the motion compensation processing unit 323, so as to calculate the cost function values in all the candidate inter prediction modes.

As specified in the JM (Joint Model), which is the reference software in H.264/AVC, the cost function values are calculated by the method of High Complexity Mode or Low Complexity Mode.

Specifically, in the High Complexity Mode, the operation that ends with the lossless encoding operation is provisionally performed in each candidate prediction mode, to calculate the cost function value expressed by the following equation (10) in each prediction mode:

Cost(ModeεΩ)=D+λ·R (10)

Here, Ω represents the universal set of the candidate prediction modes for encoding the image of the prediction unit. D represents the difference energy (distortion) between the predicted image and the input image in a case where encoding is performed in a prediction mode. R represents the bit generation rate including orthogonal transform coefficients and prediction mode information, and λ represents the Lagrange multiplier given as the function of a quantization parameter QP.

That is, to perform encoding in the High Complexity Mode, a provisional encoding operation needs to be performed in all the candidate prediction modes to calculate the above parameters D and R, and therefore, a larger amount of calculation is required.

In the Low Complexity Mode, on the other hand, predicted images, header bits containing a difference motion vector and prediction mode information, and the like are generated in all the candidate prediction modes, and cost function values expressed by the following equation (11) are calculated:

Cost(ModeεΩ)=D+QP2Quant(QP)·Header_Bit (11)

Here, Ω represents the universal set of the candidate prediction modes for encoding the image of the prediction unit. D represents the difference energy (distortion) between the predicted image and the input image in a case where encoding is performed in a prediction mode. Header_Bit represents the header bit corresponding to the prediction mode, and QP2Quant is the function given as the function of the quantization parameter QP.

That is, in the Low Complexity Mode, a prediction operation needs to be performed in each prediction mode, but any decoded image is not required. Accordingly, the amount of calculation can be smaller than that required in the High Complexity Mode.

The motion compensation processing unit 323 includes a compensation control unit 3231, a coefficient table 3232, and a filtering unit 3233. Based on the block size (as well as the shape) and motion vector of the prediction unit supplied from the mode determination unit 322, and a reference index, the compensation control unit 3231 controls the reading of the reference image data from the frame memory 26. The filtering unit 3233 performs an interpolation filtering operation to determine image data with fractional pixel precision of the reference image data of the current block. Also, based on the motion vector, the filtering unit 3233 performs motion compensation by using the image data determined through the interpolation filtering operation, to generate predicted image data. Further, the compensation control unit 3231 changes filter characteristics of the filtering unit 3233, in accordance with the size of the motion vector supplied from the mode determination unit 322. For example, the motion compensation processing unit 323 makes the filter characteristics differ between when the size of the motion vector is larger than a predetermined threshold value and when the size of the motion vector is equal to or smaller than the threshold value. The compensation control unit 3231 selects a filter coefficient from the coefficient table 3232, in accordance with the size of the motion vector, and supplies the selected filter coefficient to the filtering unit 3233, to change filter characteristics. Although a filter coefficient is supplied from the coefficient table 3232 to the filtering unit 3233 in FIG. 4, a filter coefficient may be supplied from the compensation control unit 3231 to the filtering unit 3233.

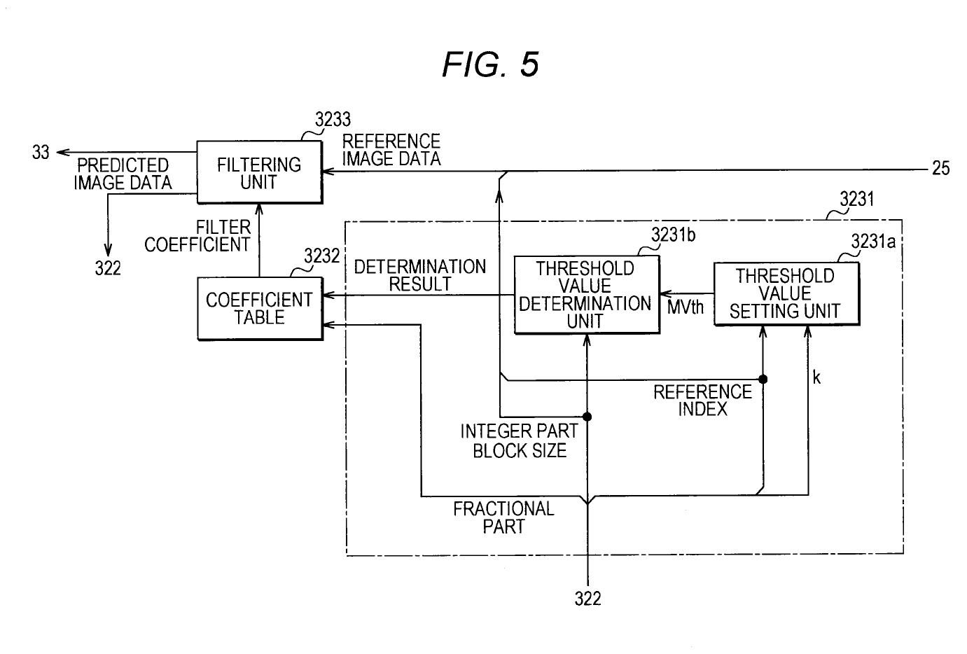

FIG. 5 is a diagram showing the structure of the portion that performs filter control in the compensation control unit 3231. The compensation control unit 3231 includes a threshold value setting unit 3231a and a threshold value determination unit 3231b.

The compensation control unit 3231 reads the reference image data from the frame memory 26, based on the block size, and the integer part of the motion vector and the reference index.

When the motion vector has integer pixel precision, the threshold value setting unit 3231a sets a threshold value Myth for changing the filter characteristics of the filtering unit 3233. The threshold value setting unit 3231a outputs the set threshold value Myth to the threshold value determination unit 3231b. The threshold value setting unit 3231a uses a predetermined fixed value as the threshold value Myth. The threshold value setting unit 3231a may also adaptively change the threshold value, depending on the distance between the frame for generating predicted image data and the frame of the reference image data in the temporal direction. Where the same motion continues, for example, the motion vector size is small when the distance between the frame for generating predicted image data and the frame of the reference image data is short in the temporal direction, and the motion vector size is large when the distance in the temporal direction is long. Accordingly, a threshold value corresponding to desired motion can be set by adaptively changing the threshold value in accordance with the distance in the temporal direction.

The equation (12) expresses the threshold value MVth that is adaptively changed in accordance with the distance in the temporal direction.

MVth=k*|POC0−POC1| (12)

In the equation (12), the coefficient k is a value that is set beforehand for calculating the threshold value Myth in accordance with the distance in the temporal direction. POC0 represents the POC (Picture Order Count) of the frame that is the frame of the predicted image data to be generated. POC1 represents the POC of the frame of the reference image data. POC0 and POC1 can be distinguished from each other by the reference index in the optimum inter prediction mode.

The threshold value determination unit 3231b determines whether the integer part of the motion vector is equal to or larger than the threshold value Myth, and outputs the determination result to the coefficient table 3232.

The fractional part of the motion vector and the determination result generated from the threshold value determination unit 3231b are supplied to the coefficient table 3232. The coefficient table 3232 also stores filter coefficients for setting filter characteristics to remove noise, filter coefficients for generating image data with fractional pixel precision by performing an interpolation filtering operation based on a motion vector with fractional pixel precision, and the like.

When the fractional part of the motion vector is zero, or when the motion vector has integer pixel precision, the coefficient table 3232 outputs a filter coefficient corresponding to the size (length) of the motion vector. For example, when the determination result indicates that the fractional part of the motion vector is zero, and the integer part is equal to or smaller than the threshold value Myth, the coefficient table 3232 outputs a first filter coefficient having such characteristics as not to perform any filtering operation, to the filtering unit 3233. When the determination result indicates that the fractional part of the motion vector is zero, and the integer part is larger than the threshold value Myth, the coefficient table 3232 outputs a second filter coefficient having such filter characteristics as to remove noise from the reference image data, to the filtering unit 3233. If the threshold value Myth is made zero here, any filtering operation is not performed on the stationary region of the image, and the denoising can be performed only on the moving region of the image.

When the fractional part of the motion vector is not zero, the coefficient table 3232 outputs a third filter coefficient for generating predicted image data based on the motion vector with fractional pixel precision or for generating predicted image data and performing denoising, to the filtering unit 3233.

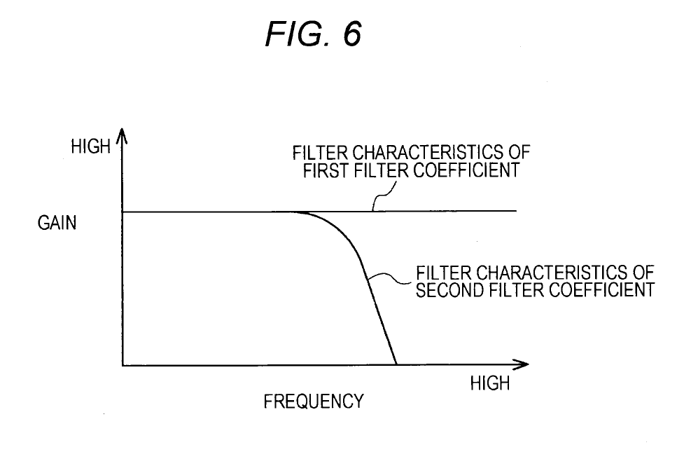

FIG. 6 shows examples of the filter characteristics achieved when the first filter coefficient is used, and the filter characteristics achieved when the second filter coefficient is used. It should be noted that the filter characteristics achieved when the first filter coefficient is used should be characteristics for performing no filtering operations, and the filter characteristics achieved when the second filter coefficient is used should be filter characteristics for removing noise. In either case, filter characteristics are not limited to those shown in FIG. 6. For example, damping characteristics that differ from the characteristics shown in FIG. 6 may be achieved.

The filtering unit 3233 performs a filtering operation on the reference image data by using the filter coefficient supplied from the coefficient table 3232, and generates predicted image data. When the mode determination unit 322 is to calculate cost function values to determine an optimum inter prediction mode, the filtering unit 3233 outputs the generated predicted image data to the mode determination unit 322. The filtering unit 3233 also outputs the predicted image data generated in the optimum inter prediction mode to the predicted image/optimum mode selection unit 33.

Although not shown in the drawing, the motion compensation processing unit 323 outputs the motion vector detected in the optimum inter prediction mode to the motion vector buffer 324, and outputs the prediction mode information about the optimum inter prediction and the difference motion vector in the mode to the lossless encoding unit 16. Further, the motion compensation processing unit 323 outputs the cost function value in the optimum inter prediction to the predicted image/optimum mode selection unit 33 shown in FIG. 3.

The predicted image/optimum mode selection unit 33 compares the cost function value supplied from the intra prediction unit 31 with the cost function value supplied from the motion prediction/compensation unit 32, and selects the smaller cost function value as the optimum mode with the highest encoding efficiency. The predicted image/optimum mode selection unit 33 also outputs the predicted image data generated in the optimum mode to the subtraction unit 13 and the addition unit 23. Further, the predicted image/optimum mode selection unit 33 outputs information indicating whether the optimum mode is an intra prediction mode or an inter prediction mode, to the lossless encoding unit 16. The predicted image/optimum mode selection unit 33 switches to an intra prediction or to an inter prediction for each slice.

### [2. Operations of the Image Encoding Device]

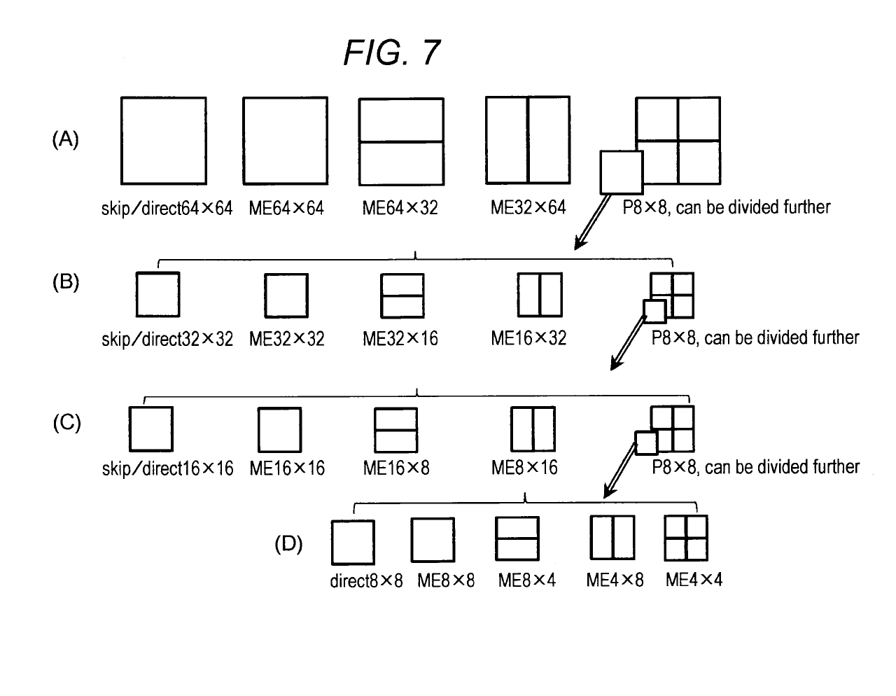

In the image encoding device, macroblock sizes are made larger than those in H.264/AVC, for example, and encoding operations are performed. FIG. 7 show a hierarchical structure where macroblock sizes are extended. Of FIG. 7, FIGS. 7(C) and 7(D) show cases where coding units are a 16×16 pixel macroblock and an 8×8 pixel sub-macroblock as specified in H.264/AVC. FIG. 7(A) shows a case where the block size of a coding unit is 64×64 pixels, FIG. 7(B) shows a case where the block size of a coding unit is 32×32 pixels. It should be noted that, in FIG. 7, each “skip/direct” indicates a block size used in a case where a skipped macroblock mode or a direct mode is selected.

In one hierarchical level, prediction units including the sizes obtained by dividing a coding unit are set. For example, on the hierarchical level of the 64×64 pixel macroblock shown in FIG. 7(A), 64×64 pixels, 64×32 pixels, 32×64 pixels, and 32×32 pixels are set as the block sizes of the prediction units belonging to the same hierarchical level. Although not shown, it is also possible to set prediction units by dividing a coding unit into two asymmetrical block sizes. It should be noted that each “ME” indicates the block size of a prediction unit. Each “P8×8” indicates that the block can be further divided on a lower hierarchical level with a smaller block size.

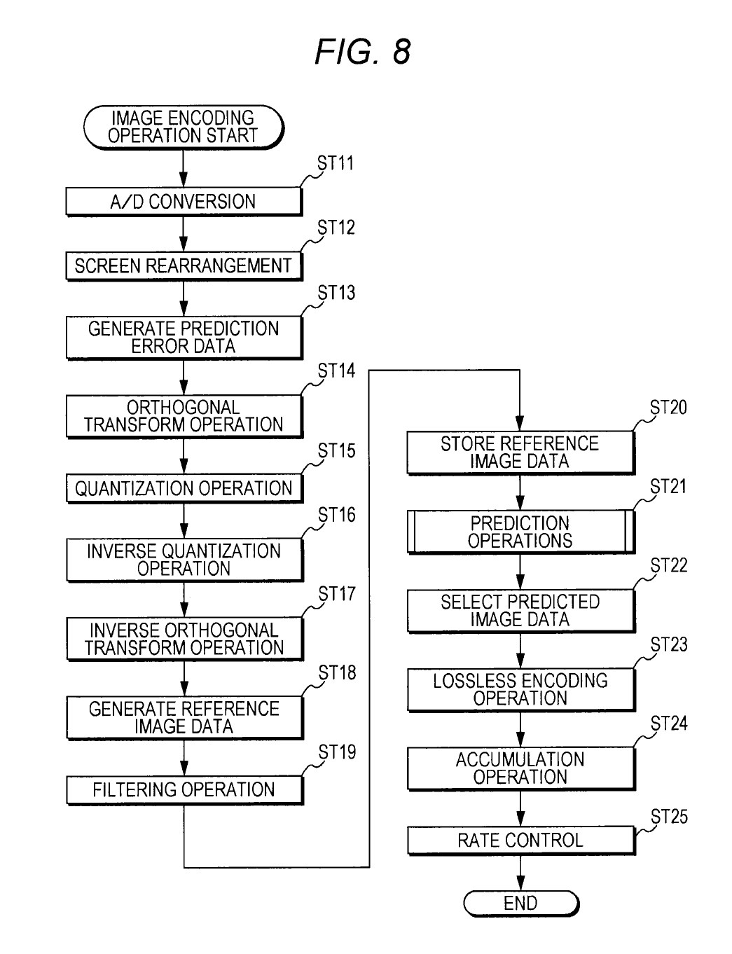

Referring now to the flowchart shown in FIG. 8, operations of the image encoding device are described. In step ST11, the A/D converter 11 performs an A/D conversion on an input image signal.

In step ST12, the screen rearrangement buffer 12 performs image rearrangement. The screen rearrangement buffer 12 stores the image data supplied from the A/D converter 11, and rearranges the respective pictures in encoding order, instead of display order.

In step ST13, the subtraction unit 13 generates prediction error data. The subtraction unit 13 generates the prediction error data by calculating the difference between the image data of the images rearranged in step ST12 and predicted image data selected by the predicted image/optimum mode selection unit 33. The prediction error data has a smaller data amount than the original image data. Accordingly, the data amount can be made smaller than in a case where images are directly encoded.

In step ST14, the orthogonal transform unit 14 performs an orthogonal transform operation. The orthogonal transform unit 14 orthogonally transforms the prediction error data supplied from the subtraction unit 13. Specifically, orthogonal transforms such as discrete cosine transforms or Karhunen-Loeve transforms are performed on the prediction error data, and transform coefficient data is output.

In step ST15, the quantization unit 15 performs a quantization operation. The quantization unit 15 quantizes the transform coefficient data. In the quantization, rate control is performed as will be described later in the description of step ST25.

In step ST16, the inverse quantization unit 21 performs an inverse quantization operation. The inverse quantization unit 21 inversely quantizes the transform coefficient data quantized by the quantization unit 15, having characteristics compatible with the characteristics of the quantization unit 15.

In step ST17, the inverse orthogonal transform unit 22 performs an inverse orthogonal transform operation. The inverse orthogonal transform unit 22 performs an inverse orthogonal transform on the transform coefficient data inversely quantized by the inverse quantization unit 21, having the characteristics compatible with the characteristics of the orthogonal transform unit 14.

In step ST18, the addition unit 23 generates reference image data. The addition unit 23 generates decoded data (reference image data) by adding the predicted image data supplied from the predicted image/optimum mode selection unit 33 to the data of the location that corresponds to the predicted image and has been subjected to the inverse orthogonal transform.

In step ST19, the deblocking filter 24 performs a filtering operation. The deblocking filter 24 removes block distortions by filtering the decoded image data output from the addition unit 23.

In step ST20, the frame memory 26 stores the reference image data. The frame memory 26 stores the filtered decoded data (reference image data).

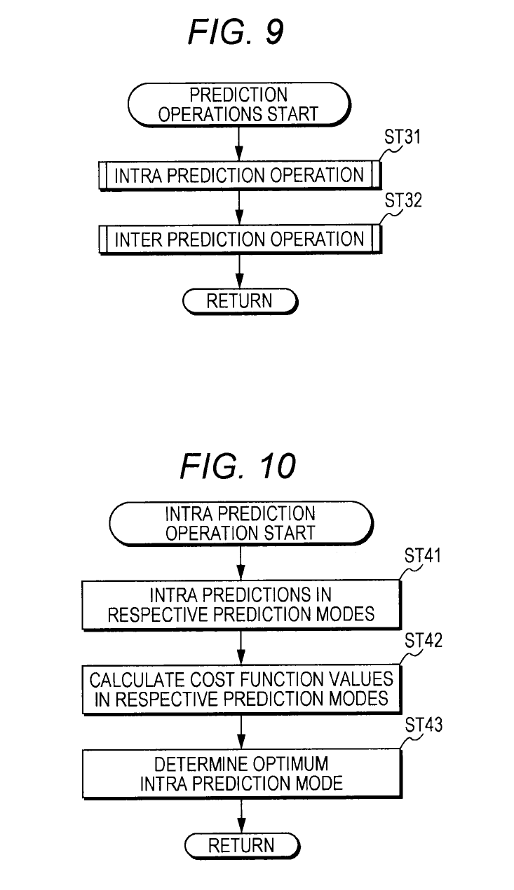

In step ST21, the intra prediction unit 31 and the motion prediction/compensation unit 32 each perform prediction operations. Specifically, the intra prediction unit 31 performs intra prediction operations in intra prediction modes, and the motion prediction/compensation unit 32 performs motion prediction/compensation operations in inter prediction modes. The prediction operations will be described later in detail with reference to FIG. 9. In this step, prediction operations are performed in all candidate prediction modes, and cost function values are calculated in all the candidate prediction modes. Based on the calculated cost function values, an optimum intra prediction mode and an optimum inter prediction mode are selected, and the predicted images generated in the selected prediction modes, the cost functions, and the prediction mode information are supplied to the predicted image/optimum mode selection unit 33.

In step ST22, the predicted image/optimum mode selection unit 33 selects predicted image data. Based on the respective cost function values output from the intra prediction unit 31 and the motion prediction/compensation unit 32, the predicted image/optimum mode selection unit 33 determines the optimum mode to optimize the encoding efficiency. That is, the predicted image/optimum mode selection unit 33 determines the coding unit with the highest encoding efficiency from the respective hierarchical levels shown in FIG. 7, the block size of each prediction unit in the selected coding unit, and which prediction is to be performed, an intra prediction or an inter prediction. The predicted image/optimum mode selection unit 33 further outputs the predicted image data in the determined optimum mode to the subtraction unit 13 and the addition unit 23. This predicted image data is used in the operations in steps ST13 and ST18, as described above.

In step ST23, the lossless encoding unit 16 performs a lossless encoding operation. The lossless encoding unit 16 performs lossless encoding on the quantized data output from the quantization unit 15. That is, lossless encoding such as variable-length encoding or arithmetic encoding is performed on the quantized data, to compress the data. The lossless encoding unit 16 also performs lossless encoding on the prediction mode information and the like corresponding to the predicted image data selected in step ST22, so that lossless-encoded data of the prediction mode information and the like is incorporated into the compressed image information generated by performing lossless encoding on the quantized data.

In step ST24, the accumulation buffer 17 performs an accumulation operation. The accumulation buffer 17 stores the compressed image information output from the lossless encoding unit 16. The compressed image information stored in the accumulation buffer 17 is read and transmitted to the decoding side via a transmission path where necessary.

In step ST25, the rate control unit 18 performs rate control. The rate control unit 18 controls the quantization operation rate of the quantization unit 15 so that an overflow or an underflow does not occur in the accumulation buffer 17 when the accumulation buffer 17 stores compressed image information.

Referring now to the flowchart in FIG. 9, the prediction operations in step ST21 in FIG. 8 are described.

In step ST31, the intra prediction unit 31 performs an intra prediction operation. The intra prediction unit 31 performs intra predictions on the image of the prediction unit being encoded in all the candidate intra prediction modes. The image data of a decoded image to be referred to in each intra prediction is decoded image data yet to be subjected to a blocking filtering operation at the deblocking filter 24. In this intra prediction operation, intra predictions are performed in all the candidate intra prediction modes, and cost function values are calculated in all the candidate intra prediction modes. Based on the calculated cost function values, the intra prediction mode with the highest encoding efficiency is selected from all the intra prediction modes.

In step ST32, the motion prediction/compensation unit 32 performs an inter prediction operation. Using the decoded image data that is stored in the frame memory 26 and has been subjected to the deblocking filtering operation, the motion prediction/compensation unit 32 performs an inter prediction operation in the candidate inter prediction modes. In this inter prediction operation, prediction operations are performed in all the candidate inter prediction modes, and cost function values are calculated in all the candidate inter prediction modes. Based on the calculated cost function values, the inter prediction mode with the highest encoding efficiency is selected from all the inter prediction modes.

Referring now to the flowchart in FIG. 10, the intra prediction operation in step ST31 in FIG. 9 is described.

In step ST41, the intra prediction unit 31 performs intra predictions in the respective prediction modes. Using the decoded image data yet to be subjected to the blocking filtering operation, the intra prediction unit 31 generates predicted image data in each intra prediction mode.

In step ST42, the intra prediction unit 31 calculates the cost function value in each prediction mode. As specified in the JM (Joint Model), which is the reference software in H.264/AVC, the cost function values are calculated by the method of High Complexity Mode or Low Complexity Mode as described above, for example. Specifically, in the High Complexity Mode, the operation that ends with the lossless encoding operation is provisionally performed as the operation of step ST42 in all the candidate prediction modes, to calculate the cost function value expressed by the above described equation (10) in each prediction mode. In the Low Complexity Mode, on the other hand, the generation of a predicted image and the calculation of the header bit such as a motion vector and prediction mode information are performed as the operation of step ST42 in all the candidate prediction modes, and the cost function value expressed by the above described equation (11) is calculated in each prediction mode.

In step ST43, the intra prediction unit 31 determines the optimum intra prediction mode. Based on the cost function values calculated in step ST42, the intra prediction unit 31 selects the one intra prediction mode with the smallest cost function value among the calculated cost function values, and determines the selected intra prediction mode to be the optimum intra prediction mode.

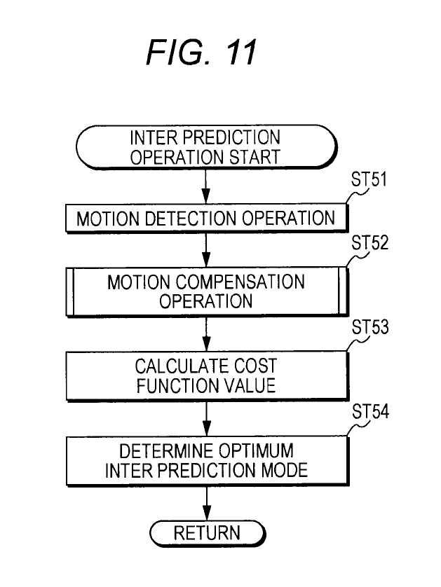

Referring now to the flowchart in FIG. 11, the inter prediction operation in step ST32 in FIG. 9 is described.

In step ST51, the motion prediction/compensation unit 32 performs a motion detection operation. The motion prediction/compensation unit 32 detects a motion vector, and moves on to step ST52.

In step ST52, the motion prediction/compensation unit 32 performs a motion compensation operation. Based on the motion vector detected in step ST51, the motion prediction/compensation unit 32 performs motion compensation and generates predicted image data by using the reference image data.

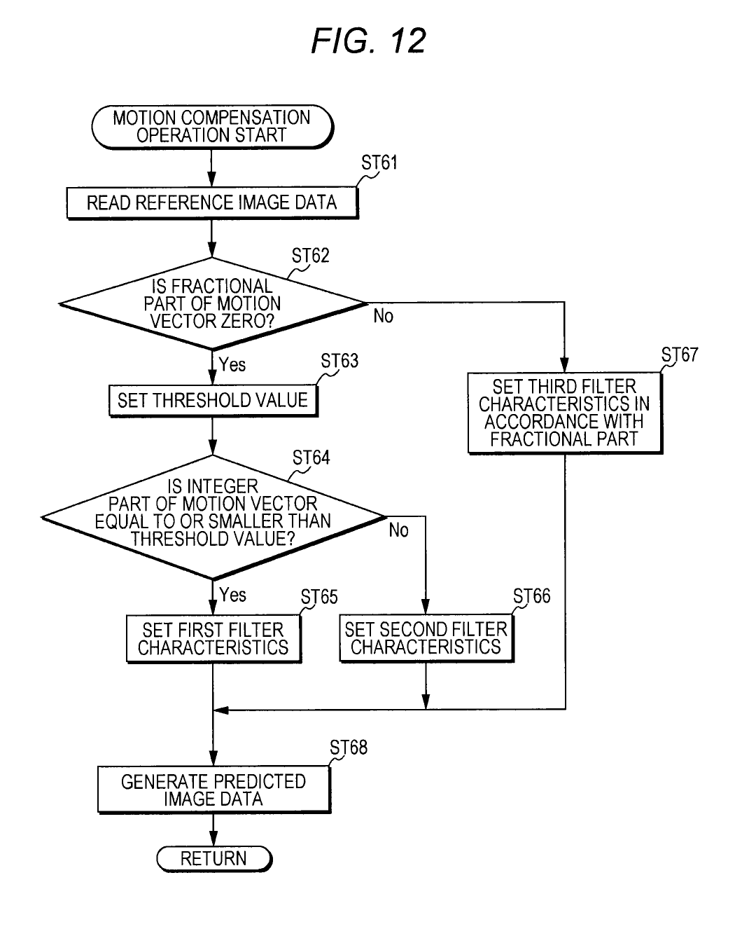

FIG. 12 is a flowchart showing the motion compensation operation. In step ST61, the motion prediction/compensation unit 32 reads the reference image data. Based on the block size of the prediction unit being subjected to the motion compensation, the motion vector detected from the prediction unit being subjected to the motion compensation, and the reference index indicating the reference image used in detecting the motion vector, the motion prediction/compensation unit 32 determines the region from which the reference image data is to be read. Further, the motion prediction/compensation unit 32 reads the image data of the determined read region from the frame memory 26, and moves on to step ST62.

In step ST62, the motion prediction/compensation unit 32 determines whether the fractional part of the motion vector is zero. When the fractional part of the motion vector detected from the prediction unit being subjected to the motion compensation is zero, the motion prediction/compensation unit 32 moves on to step ST63. When the fractional part of the motion vector is not zero, the motion prediction/compensation unit 32 moves on to step ST67.

In step ST63, the motion prediction/compensation unit 32 sets a threshold value. Based on a predetermined fixed value, or the above mentioned equation (12), the motion prediction/compensation unit 32 sets the threshold value Myth, and moves on to step ST64.

In step ST64, the motion prediction/compensation unit 32 determines whether the integer part is equal to or smaller than the threshold value. When the integer part of the motion vector detected from the prediction unit being subjected to motion compensation is equal to or smaller than the threshold value Myth, the motion prediction/compensation unit 32 moves on to step ST65. When the integer part is larger than the threshold value Myth, the motion prediction/compensation unit 32 moves on to step ST66.

In step ST65, the motion prediction/compensation unit 32 selects the first filter coefficient. The motion prediction/compensation unit 32 sets the first filter coefficient that is the filter coefficient to be used in a filtering operation to perform motion compensation with the use of the reference image data and generate predicted image data, and then moves on to step ST68. This first filter coefficient is the filter coefficient that has such characteristics as to perform no filtering operations, and pass the reference image data without denoising at the filtering unit 3233 when predicted image data is generated.

In step ST66, the motion prediction/compensation unit 32 selects the second filter coefficient. The motion prediction/compensation unit 32 sets the second filter coefficient that is the filter coefficient to be used in a filtering operation, and then moves on to step ST68. This second filter coefficient is a filter coefficient having such characteristics as to remove noise at the filtering unit 3233 when predicted image data is generated, or to perform a low-pass filtering operation and perform denoising.

When moving from step ST62 on to step ST67, the motion prediction/compensation unit 32 selects the third filter coefficient in accordance with the fractional part. The motion prediction/compensation unit 32 sets the third filter coefficient in accordance with the fractional part of the motion vector, and the filter third coefficient is to be used in a filtering operation to perform motion compensation with the use of the reference image data and generate predicted image data. The motion prediction/compensation unit 32 then moves on to step ST68. This third filter coefficient is a filter coefficient having such characteristics as to generate predicted image data based on the motion vector with fractional pixel precision, or to generate predicted image data and perform denoising, as in a conventional image encoding device.

In step ST68, the motion prediction/compensation unit 32 generates predicted image data. The motion prediction/compensation unit 32 generates the predicted image data by performing a filtering operation with the use of a filter coefficient selected from the first through third filter coefficients.

The predicted image data is generated in the above described manner in the motion compensation operation of step ST52 in FIG. 11, and the operation then moves on to step ST53.

In step ST53, the motion prediction/compensation unit 32 calculates a cost function value. Using the input image data of the prediction unit to be encoded, the predicted image data generated in step ST52, and the like, the motion prediction/compensation unit 32 calculates the cost function value as described above, and moves on to step ST54.

In step ST54, the motion prediction/compensation unit 32 determines the optimum inter prediction mode. The motion prediction/compensation unit 32 carries out the procedures of steps ST51 through ST53 for all the inter prediction modes, and determines the reference index with the smallest cost function value among the calculated ones, the block size of the coding unit, and the block size of the prediction unit in the coding unit. In this manner, the optimum inter prediction mode is determined. In determining the mode with the smallest cost function value, the cost function values calculated when inter predictions are performed in a skip mode are also used.

When predicted image/optimum mode selection unit 33 selects the optimum inter prediction mode as the optimum prediction mode, the motion prediction/compensation unit 32 generates predicted image data so that the predicted image data in the optimum inter prediction mode can be supplied to the subtraction unit 13 and the addition unit 23.

As described above, in the image encoding device 10, when the integer part of the motion vector with integer pixel precision is equal to or smaller than the threshold value in an inter prediction, the first filter coefficient is selected, and denoising is not performed on the reference image data. Therefore, when a large amount of high-pass components is contained in the reference image data due to a small motion size and less motion blurring, such as when the motion size is zero, the high-pass components are not lost during the filtering operations. Accordingly, deterioration in the quality of predicted images can be prevented.

When the motion vector has integer pixel precision with a larger integer part than the threshold value, the second filter coefficient is selected, and denoising is performed on the reference image data. Accordingly, where the motion size is large and motion blurring often occurs, predicted image data with less noise is generated. Thus, an encoding operation can be performed with high efficiency. Where the motion size is large, the amount of high-pass components is often smaller than that in a case where the motion size is small. Accordingly, even if denoising is performed, deterioration in the quality of predicted images due to the decrease in the amount of high-pass components is small.

Further, when the motion vector has fractional pixel precision such as ½ pixel precision or ¼ pixel precision, the third filter coefficient is selected, and a filtering operation such as generation of predicted image data through an interpolation filtering operation and denoising is performed. Accordingly, a highly-efficient encoding operation can be performed by using a small amount of predicted image data based on a motion vector with fractional pixel precision.

Also, in the image encoding device 10, the threshold value Myth or the coefficient k that is the threshold value generation information for generating the set threshold value Myth at the time of decoding is subjected to lossless encoding and is thus contained in at least one of the following pieces of information: Sequence Parameter Set (SPS), Picture Parameter Set (PPS), the slice header, the macroblock header, the coding unit header information, and the like. With this arrangement, the later described image decoding device 50 can correctly change filter characteristics in the same manner as the image encoding device 10, by using the threshold value MVth or the threshold value generation information contained in those pieces of information.

### [3. Structure of an Image Decoding Device]

Next, a case where an image processing device is applied to an image decoding device is described. Compressed image information generated by encoding an input image is supplied to an image decoding device via a predetermined transmission path or a recording medium or the like, and is decoded therein.

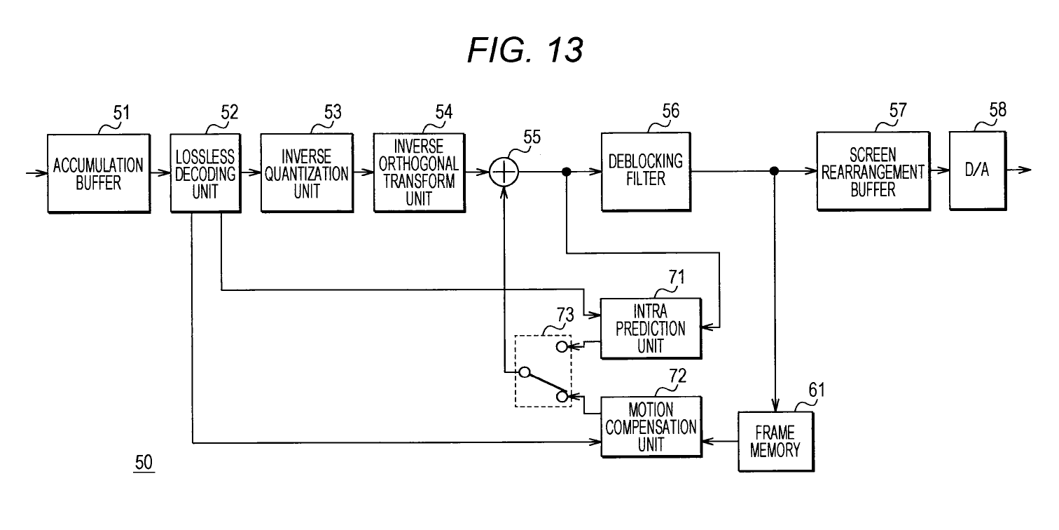

FIG. 13 shows the structure of an image decoding device that performs decoding operations on compressed image information. The image decoding device 50 includes an accumulation buffer 51, a lossless decoding unit 52, an inverse quantization unit 53, an inverse orthogonal transform unit 54, an addition unit 55, a deblocking filter 56, a screen rearrangement buffer 57, and a digital/analog converter (a D/A converter) 58. The image decoding device 50 further includes a frame memory 61, an intra prediction unit 71, a motion compensation unit 72, and a selector 73.

The accumulation buffer 51 stores transmitted compressed image information. The lossless decoding unit 52 decodes the compressed image information supplied from the accumulation buffer 51 by a method compatible with the encoding method used by the lossless encoding unit 16 shown in FIG. 3.

The lossless decoding unit 52 outputs the prediction mode information obtained by decoding the compressed image information to the intra prediction unit 71 and the motion compensation unit 72. The lossless decoding unit 52 also outputs a difference motion vector obtained by decoding the compressed image information and a threshold value or threshold value generation information to the motion compensation unit 72.

The inverse quantization unit 53 inversely quantizes the quantized data decoded by the lossless decoding unit 52, using a method compatible with the quantization method used by the quantization unit 15 shown in FIG. 3. The inverse orthogonal transform unit 54 performs an inverse orthogonal transform on the output from the inverse quantization unit 53 by a method compatible with the orthogonal transform method used by the orthogonal transform unit 14 shown in FIG. 3, and outputs the result to the addition unit 55.

The addition unit 55 generates decoded image data by adding the data subjected to the inverse orthogonal transform to predicted image data supplied from the selector 73, and outputs the decoded image data to the deblocking filter 56 and the intra prediction unit 71.

The deblocking filter 56 performs a deblocking filtering operation on the decoded image data supplied from the addition unit 55, and removes block distortions. The resultant data is supplied to and stored in the frame memory 61, and is also output to the screen rearrangement buffer 57.

The screen rearrangement buffer 57 performs image rearrangement. Specifically, the frame order rearranged in the order of encoding by the screen rearrangement buffer 12 shown in FIG. 3 is rearranged in the original display order, and is output to the D/A converter 58.

The D/A converter 58 performs a D/A conversion on the image data supplied from the screen rearrangement buffer 57, and outputs the converted image data to a display (not shown) to display the images.

The frame memory 61 stores reference image data that is the decoded image data subjected to the filtering operation at the deblocking filter 24.

Based on the prediction mode information supplied from the lossless decoding unit 52 and the decoded image data supplied from the addition unit 55, the intra prediction unit 71 generates predicted image data, and outputs the generated predicted image data to the selector 73.

Based on the prediction mode information and difference motion vector supplied from the lossless decoding unit 52, the motion compensation unit 72 performs motion compensation by reading the reference image data from the frame memory 61, and generates predicted image data. The motion compensation unit 72 outputs the generated predicted image data to the selector 73. The motion compensation unit 72 also changes filter characteristics and generates predicted image data, in accordance with the size of the motion vector.

Based on the prediction mode information supplied from the lossless decoding unit 52, the selector 73 selects the intra prediction unit 71 in the case of an intra prediction, and selects the motion compensation unit 72 in the case of an inter prediction. The selector 73 outputs the predicted image data generated at the selected intra prediction unit 71 or motion compensation unit 72 to the addition unit 55.

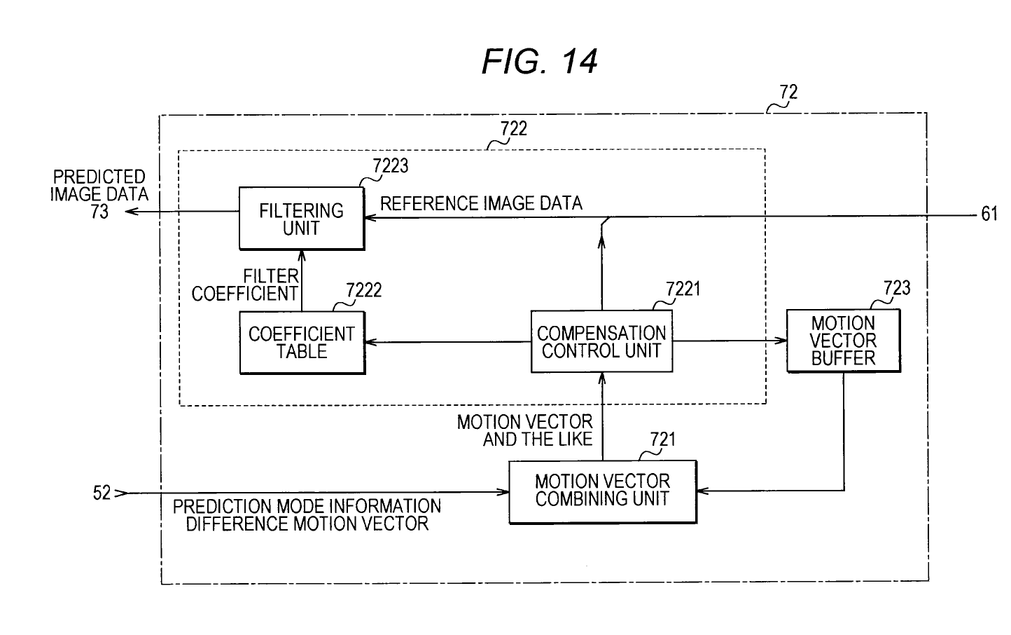

FIG. 14 shows the structure of the motion compensation unit 72. The motion compensation unit 72 includes a motion vector combining unit 721, a motion compensation processing unit 722, and a motion vector buffer 723.

The motion vector combining unit 721 calculates the motion vector of the prediction unit by adding the difference motion vector and the predicted motion vector that are of the prediction unit to be decoded and are supplied from the lossless decoding unit 52. The motion vector of the prediction unit is then output to the motion compensation processing unit 722. The motion vector combining unit 721 generates the predicted motion vector by using the motion vector of an adjacent prediction unit stored in the motion vector buffer 723.

The motion compensation processing unit 722 includes a compensation control unit 7221, a coefficient table 7222, and a filtering unit 7223. Based on the prediction mode information supplied from the lossless decoding unit 52 and the motion vector supplied from the motion vector combining unit 721, the compensation control unit 7221 controls the reading of the reference image data from the frame memory 61. The filtering unit 7223 performs an interpolation filtering operation to determine image data with fractional pixel precision of the reference image data of the current block. Also, based on the motion vector, the filtering unit 7223 performs motion compensation by using the image data determined through the interpolation filtering operation, to generate predicted image data. Further, the compensation control unit 7221 changes filter characteristics of the filtering unit 7223, in accordance with the size of the motion vector supplied from the motion vector combining unit 721. The compensation control unit 7221 selects a filter coefficient from the coefficient table 7222, in accordance with the size of the motion vector, and supplies the selected filter coefficient to the filtering unit 7223, to change filter characteristics. Alternatively, the compensation control unit 7221 changes filter characteristics in the same manner as the compensation control unit 3231 shown in FIG. 4, by using the threshold value supplied from the lossless decoding unit 52, or using a threshold value calculated according to the equation (12) using threshold value generation information supplied from the lossless decoding unit 52. Accordingly, where the threshold value is made zero by the compensation control unit 3231, any filtering operation is not performed on the stationary region of the image, and denoising can be performed only on the moving region of the image in the image decoding device 50.

Like the coefficient table 3232, the coefficient table 7222 outputs a filter coefficient for performing denoising in accordance with the size of a motion vector when predicted image data is generated based on the motion vector with integer pixel precision. For example, when the determination result indicates that the fractional part of the motion vector is zero, and the integer part is equal to or smaller than the threshold value Myth, the coefficient table 7222 outputs a filter coefficient for not performing denoising on predicted image data, to the filtering unit 7223. When the determination result indicates that the fractional part of the motion vector is zero, and the integer part is larger than the threshold value Myth, the coefficient table 7222 outputs a filter coefficient for performing denoising on predicted image data, to the filtering unit 7223.

Further, like the coefficient table 3232, the coefficient table 7222 outputs a filter coefficient for generating predicted data, or for generating predicted image data and performing denoising, to the filtering unit 7223, when the predicted image data is generated based on a motion vector with fractional pixel precision. That is, when the fractional part of the motion vector is not zero, the coefficient table 7222 outputs a filter coefficient for generating predicted image data or for generating predicted image data and performing denoising, to the filtering unit 7223, in accordance with the fractional part of the motion vector.

The filtering unit 7223 performs a filtering operation on the reference image data by using the filter coefficient supplied from the coefficient table 7222, and generates and outputs predicted image data to the selector 73 shown in FIG. 13.

Based on the prediction mode information supplied from the lossless decoding unit 52, the selector 73 selects the intra prediction unit 71 in the case of an intra prediction, and selects the motion compensation unit 72 in the case of an inter prediction. The selector 73 outputs the predicted image data generated at the selected intra prediction unit 71 or motion compensation unit 72 to the addition unit 55.

### [4. Operations of the Image Decoding Device]

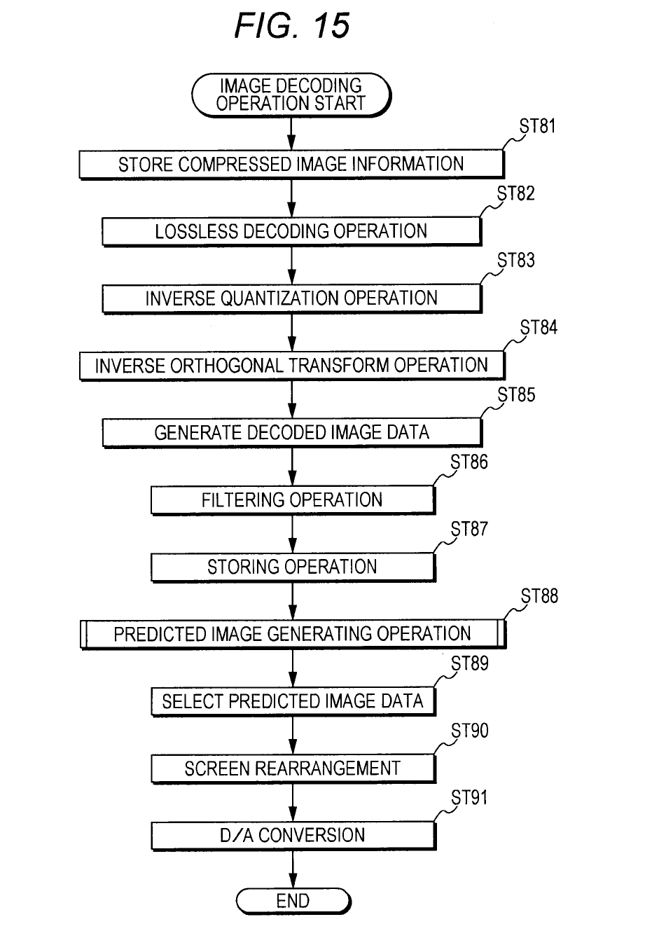

Referring now to the flowchart in FIG. 15, an image decoding operation to be performed by the image decoding device 50 is described.

In step ST81, the accumulation buffer 51 stores supplied compressed image information. In step ST82, the lossless decoding unit 52 performs a lossless decoding operation. The lossless decoding unit 52 decodes the compressed image information supplied from the accumulation buffer 51. Specifically, the quantized data of each picture encoded by the lossless encoding unit 16 shown in FIG. 3 is obtained. The lossless decoding unit 52 also performs lossless decoding on the prediction mode information and the like contained in the compressed image information. When the obtained prediction mode information is information about an intra prediction mode, the prediction mode information is output to the intra prediction unit 71. When the prediction mode information is information about an inter prediction mode, on the other hand, the lossless decoding unit 52 outputs the prediction mode information to the motion compensation unit 72. The lossless decoding unit 52 further outputs a difference motion vector obtained by decoding the compressed image information and a threshold value or threshold value generation information to the motion compensation unit 72.

In step ST83, the inverse quantization unit 53 performs an inverse quantization operation. The inverse quantization unit 53 inversely quantizes the quantized data decoded by the lossless decoding unit 52, having characteristics compatible with the characteristics of the quantization unit 15 shown in FIG. 3.

In step ST84, the inverse orthogonal transform unit 54 performs an inverse orthogonal transform operation. The inverse orthogonal transform unit 54 performs an inverse orthogonal transform on the transform coefficient data inversely quantized by the inverse quantization unit 53, having the characteristics compatible with the characteristics of the orthogonal transform unit 14 shown in FIG. 3.

In step ST85, the addition unit 55 generates decoded image data. The addition unit 55 adds the data obtained through the inverse orthogonal transform operation to predicted image data selected in step ST89, which will be described later, and generates the decoded image data. In this manner, the original images are decoded.

In step ST86, the deblocking filter 56 performs a filtering operation. The deblocking filter 56 performs a deblocking filtering operation on the decoded image data output from the addition unit 55, and removes block distortions contained in the decoded images.

In step ST87, the frame memory 61 performs a decoded image data storing operation. It should be noted that the decoded image data stored in the frame memory 61 and the decoded image data output from the addition unit 55 are used in generating predicted image data as reference image data.

In step ST88, the intra prediction unit 71 and the motion compensation unit 72 perform predicted image generating operations. The intra prediction unit 71 and the motion compensation unit 72 each perform a predicted image generating operation in accordance with the prediction mode information supplied from the lossless decoding unit 52.

Specifically, when prediction mode information about intra predictions has been supplied from the lossless decoding unit 52, the intra prediction unit 71 generates predicted image data based on the prediction mode information. When prediction mode information about inter predictions has been supplied from the lossless decoding unit 52, on the other hand, the motion compensation unit 72 performs motion compensation based on the prediction mode information, to generate predicted image data.

In step ST89, the selector 73 selects predicted image data. The selector 73 selects the predicted image supplied from the intra prediction unit 71 or the predicted image data supplied from the motion compensation unit 72, and supplies the selected predicted image data to the addition unit 55, which adds the selected predicted image data to the output from the inverse orthogonal transform unit 54 in step ST85, as described above.

In step ST90, the screen rearrangement buffer 57 performs image rearrangement. Specifically, the order of frames rearranged for encoding by the screen rearrangement buffer 12 of the image encoding device 10 shown in FIG. 3 is rearranged in the original display order by the screen rearrangement buffer 57.

In step ST91, the D/A converter 58 performs a D/A conversion on the image data supplied from the screen rearrangement buffer 57. The images are output to the display (not shown), and are displayed.

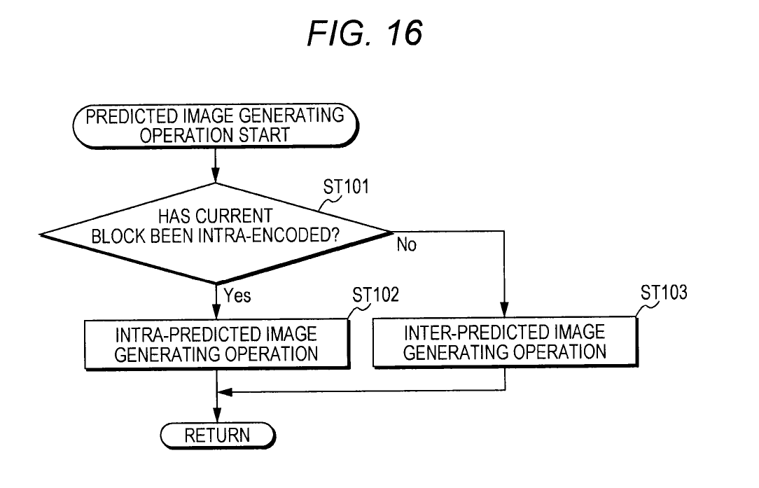

Referring now to the flowchart in FIG. 16, the predicted image generating operation in step ST88 in FIG. 15 is described.

In step ST101, the lossless decoding unit 52 determines whether the block of the prediction unit to be decoded has been intra-encoded. When the prediction mode information obtained by performing lossless decoding is prediction mode information about intra predictions, the lossless decoding unit 52 supplies the prediction mode information to the intra prediction unit 71, and moves on to step ST102. When the prediction mode information is prediction mode information about inter predictions, on the other hand, the lossless decoding unit 52 supplies the prediction mode information to the motion compensation unit 72, and moves on to step ST103.

In step ST102, the intra prediction unit 71 performs an intra-predicted image generating operation.

Using the prediction mode information and the decoded image data that has not been subjected to the deblocking filtering operation and has been supplied from the addition unit 55, the intra prediction unit 71 performs an intra prediction, to generate predicted image data.

In step ST103, the motion compensation unit 72 performs an inter-predicted image generating operation. Based on the prediction mode information and the like supplied from the lossless decoding unit 52, the motion compensation unit 72 reads the reference image data from the frame memory 61, and generates predicted image data.

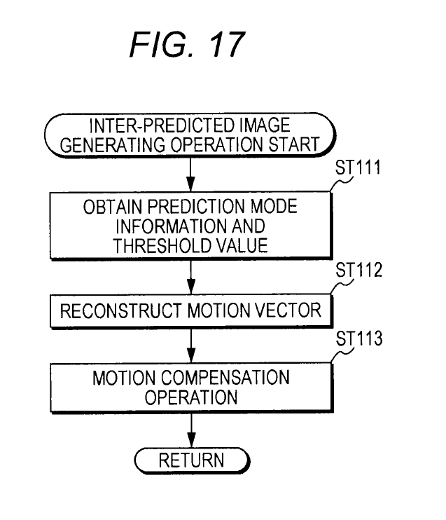

FIG. 17 is a flowchart showing the inter-predicted image generating operation of step ST103. In step ST111, the motion compensation unit 72 obtains prediction mode information and a threshold value. The motion compensation unit 72 obtains the prediction mode information and the threshold value or threshold value generation information from the lossless decoding unit 52, and moves on to step ST112.

In step ST112, the motion compensation unit 72 reconfigures a motion vector. The motion compensation unit 72 adds a predicted motion vector generated through a median prediction using the motion vector of an adjacent prediction unit, for example, to a difference motion vector supplied from the lossless decoding unit 52. By adding the predicted motion vector and the difference motion vector, the motion compensation unit 72 reconfigures the motion vector of the prediction unit, and then moves on to step ST113.

In step ST113, the motion compensation unit 72 performs a motion compensation operation. Based on the prediction mode information obtained in step ST111 and the motion vector reconfigured in step ST112, the motion compensation unit 72 reads the reference image data from the frame memory 61. The motion compensation unit 72 also changes filter characteristics in accordance with the size of the motion vector with respect to the read reference image data, and generates predicted image data, in the same manner as in the motion compensation operation shown in FIG. 11.

As described above, in the image decoding device 50, when the motion vector has integer pixel precision having an integer part equal to or smaller than the threshold value in an inter prediction, the first filter coefficient is selected, and a filtering operation is not performed on the reference image data, as in the image encoding device 10. Therefore, when a large amount of high-pass components is contained in the reference image data due to a small motion size and less motion blurring, such as when the motion size is zero, the high-pass components are not lost during the filtering operations. Accordingly, deterioration in the quality of predicted images can be prevented.

When the motion vector has integer pixel precision with a larger integer part than the threshold value, the second filter coefficient is selected, and denoising is performed on the reference image data. Accordingly, where the motion size is large and motion blurring often occurs, predicted image data with less noise is generated. Thus, an encoding operation can be performed with high efficiency. Where the motion size is large, the amount of high-pass components is often smaller than that in a case where the motion size is small. Accordingly, even if denoising is performed, deterioration in the quality of predicted images due to the decrease in the amount of high-pass components is small.

Further, when the motion vector has fractional pixel precision such as ½ pixel precision or ¼ pixel precision, the third filter coefficient is selected, and a filtering operation such as generation of predicted image data through an interpolation filtering operation and denoising is performed. Accordingly, a highly-efficient encoding operation can be performed by using a small amount of predicted image data based on a motion vector with fractional pixel precision.

Also, since filter characteristics are changed based on the threshold value MVth or threshold value setting information obtained from Sequence Parameter Set (SPS), Picture Parameter Set (PPS), the slice header, the macroblock header, or the coding unit header information, for example, the image decoding device 50 can correctly change filter characteristics in the same manner as the image encoding device 10.

In the image encoding device 10 and the image decoding device 50, when the size of a motion vector is larger than a set threshold value, filter characteristics are changed to characteristics for removing noise from reference image data, and, when the size of the motion vector is equal to or smaller than the threshold value, the filter characteristics are changed to characteristics for not performing any filtering operation. However, the filter characteristics may be changed in accordance with the size of a motion vector even when the size of the motion vector has fractional pixel precision. Also, more than one threshold value may be set, so as to perform the changing of filter characteristics with higher precision.

### [5. Software Processing]

The above described series of operations can be performed by hardware, software, or a combination of hardware and software. When operations are performed by software, a program in which the operation sequences are recorded is installed in a memory incorporated into special-purpose hardware in a computer. Alternatively, the operations can be performed by installing the program into a general-purpose computer that can perform various kinds of operations.

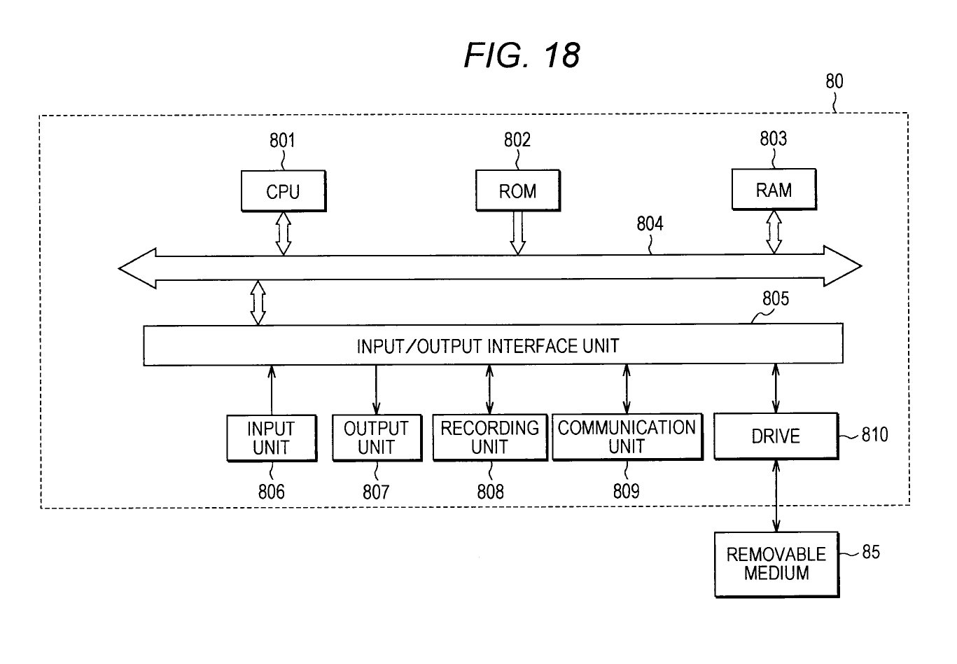

FIG. 18 is a diagram showing an example structure of a computer device that performs the above described series of operations in accordance with a program. A CPU 801 of a computer device 80 performs various kinds of operations in accordance with a program recorded on a ROM 802 or a recording unit 808.

Programs to be executed by the CPU 801 and various kinds of data are stored in a RAM 803 as appropriate. The CPU 801, the ROM 802, and the RAM 803 are connected to one another by a bus 804.

An input/output interface 805 is also connected to the CPU 801 via the bus 804. An input unit 806 such as a touch panel, a keyboard, a mouse, or a microphone, and an output unit 807 formed with a display or the like are connected to the input/output interface 805. The CPU 801 performs various kinds of operations in accordance with instructions that are input through the input unit 806. The CPU 801 outputs the operation results to the output unit 807.

The recording unit 808 connected to the input/output interface 805 is formed with a hard disk, for example, and records programs to be executed by the CPU 801 and various kinds of data. A communication unit 809 communicates with an external device via a wired or wireless communication medium such as a network like the Internet or a local area network, or digital broadcasting. Alternatively, the computer device 80 may obtain a program via the communication unit 809, and record the program on the ROM 802 or the recording unit 808.

When a removable medium 85 that is a magnetic disk, an optical disk, a magnetooptical disk, a semiconductor memory, or the like is mounted, a drive 810 drives the medium, to obtain a recorded program or recorded data. The obtained program or data is transferred to the ROM 802, the RAM 803, or the recording unit 808, where necessary.

The CPU 801 reads and executes the program for performing the above described series of operations, to perform encoding operations on image signals recorded on the recording unit 808 or the removable medium 85 and on image signals supplied via the communication unit 809, and perform decoding operations on compressed image information.

### [6. Applications to Electronic Apparatuses]

In the above described examples, H.264/AVC is used as the encoding/decoding method. However, the present technique can be applied to image encoding devices and image decoding devices that use other encoding/decoding methods for performing motion prediction/compensation operations.

Further, the present technique can be applied to image encoding devices and image decoding devices that are used when image information (bit streams) compressed through orthogonal transforms such as discrete cosine transforms and motion compensation as in MPEG, H.26x, or the like is received via a network medium such as satellite broadcasting, cable TV (television), the Internet, or a portable telephone device, or is processed in a storage medium such as an optical or magnetic disk or a flash memory.

The following is a description of electronic apparatuses to which the above described image encoding device 10 or the image decoding device 50 is applied.

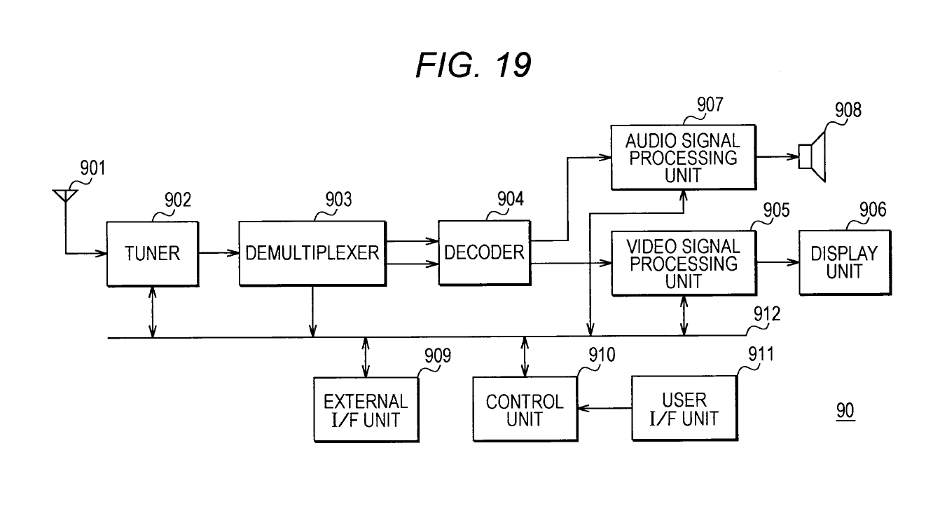

FIG. 19 schematically shows an example structure of a television apparatus to which the present technique is applied. The television apparatus 90 includes an antenna 901, a tuner 902, a demultiplexer 903, a decoder 904, a video signal processing unit 905, a display unit 906, an audio signal processing unit 907, a speaker 908, and an external interface unit 909. The television apparatus 90 further includes a control unit 910, a user interface unit 911, and the like.

The tuner 902 selects a desired channel from broadcast wave signals received at the antenna 901, and performs demodulation. The resultant stream is output to the demultiplexer 903.

The demultiplexer 903 extracts the video and audio packets of the show to be viewed from the stream, and outputs the data of the extracted packets to the decoder 904. The demultiplexer 903 also outputs a packet of data such as EPG (Electronic Program Guide) to the control unit 910. Where scrambling is performed, the demultiplexer or the like cancels the scrambling.

The decoder 904 performs a packet decoding operation, and outputs the video data generated through the decoding operation to the video signal processing unit 905, and the audio data to the audio signal processing unit 907.

The video signal processing unit 905 subjects the video data to denoising and video processing or the like in accordance with user settings. The video signal processing unit 905 generates video data of the show to be displayed on the display unit 906, or generates image data or the like through an operation based on an application supplied via a network. The video signal processing unit 905 also generates video data for displaying a menu screen or the like for item selection, and superimposes the video data on the video data of the show. Based on the video data generated in this manner, the video signal processing unit 905 generates a drive signal to drive the display unit 906.

Based on the drive signal from the video signal processing unit 905, the display unit 906 drives a display device (a liquid crystal display element, for example) to display the video of the show.

The audio signal processing unit 907 subjects the audio data to predetermined processing such as denoising, and performs a D/A conversion operation and an amplifying operation on the processed audio data. The resultant audio data is supplied as an audio output to the speaker 908.

The external interface unit 909 is an interface for a connection with an external device or a network, and transmits and receives data such as video data and audio data.

The user interface unit 911 is connected to the control unit 910. The user interface unit 911 is formed with operation switches, a remote control signal reception unit, and the like, and supplies an operating signal according to a user operation to the control unit 910.

The control unit 910 is formed with a CPU (Central Processing Unit), a memory, and the like. The memory stores the program to be executed by the CPU, various kinds of data necessary for the CPU to perform operations, EPG data, data obtained via a network, and the like. The program stored in the memory is read and executed by the CPU at a predetermined time such as the time of activation of the television apparatus 90. The CPU executes the program to control the respective components so that the television apparatus 90 operates in accordance with user operations.

In the television apparatus 90, a bus 912 is provided for connecting the tuner 902, the demultiplexer 903, the video signal processing unit 905, the audio signal processing unit 907, the external interface unit 909, and the like to the control unit 910.

In the television apparatus having such a structure, the decoder 904 has the functions of an image decoding device (an image decoding method) of the present invention. Accordingly, where predicted image data has been generated by changing filter characteristics in accordance with a motion vector in an image encoding operation on the broadcast station side, predicted image data can be generated by changing filter characteristics in the same manner as the broadcast station side. Thus, a correct decoding operation can be performed in the television apparatus, while decreases in compression efficiency due to degradation in the quality of predicted images are prevented.

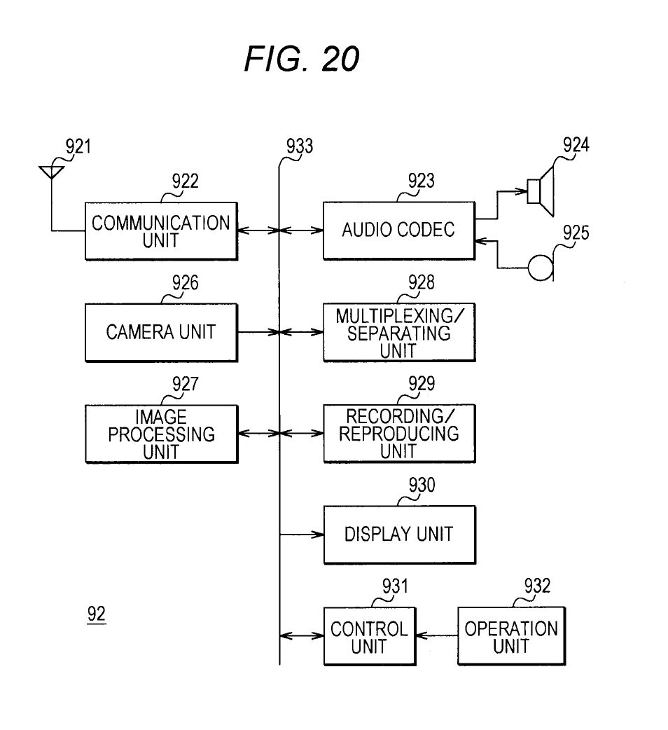

FIG. 20 schematically shows an example structure of a portable telephone device to which the present technique is applied. The portable telephone device 92 includes a communication unit 922, an audio codec 923, a camera unit 926, an image processing unit 927, a multiplexing/separating unit 928, a recording/reproducing unit 929, a display unit 930, and a control unit 931. Those components are connected to one another via a bus 933.

Also, an antenna 921 is connected to the communication unit 922, and a speaker 924 and a microphone 925 are connected to the audio codec 923. Further, an operation unit 932 is connected to the control unit 931.

The portable telephone device 92 performs various kinds of operations such as transmission and reception of audio signals, transmission and reception of electronic mail and image data, image capturing, and data recording, in various kinds of modes such as an audio communication mode and a data communication mode.

In the audio communication mode, an audio signal generated at the microphone 925 is converted into audio data, and the data is compressed at the audio codec 923. The compressed data is supplied to the communication unit 922. The communication unit 922 performs a modulation operation, a frequency conversion operation, and the like on the audio data, to generate a transmission signal. The communication unit 922 also supplies the transmission signal to the antenna 921, and the transmission signal is transmitted to a base station (not shown). The communication unit 922 also amplifies a signal received at the antenna 921, and performs a frequency conversion operation, a demodulation operation, and the like. The resultant audio data is supplied to the audio codec 923. The audio codec 923 decompresses audio data, and converts the audio data into an analog audio signal. The analog audio signal is then output to the speaker 924.

When mail transmission is performed in the data communication mode, the control unit 931 receives text data that is input by operating the operation unit 932, and the input text is displayed on the display unit 930. In accordance with a user instruction or the like through the operation unit 932, the control unit 931 generates and supplies mail data to the communication unit 922. The communication unit 922 performs a modulation operation, a frequency conversion operation, and the like on the mail data, and transmits the resultant transmission signal from the antenna 921. The communication unit 922 also amplifies a signal received at the antenna 921, and performs a frequency conversion operation, a demodulation operation, and the like, to decompress the mail data. This mail data is supplied to the display unit 930, and the content of the mail is displayed.

The portable telephone device 92 can cause the recording/reproducing unit 929 to store received mail data into a storage medium. The storage medium is a rewritable storage medium. For example, the storage medium may be a semiconductor memory such as a RAM or an internal flash memory, a hard disk, or a removable medium such as a magnetic disk, a magnetooptical disk, an optical disk, a USB memory, or a memory card.

When image data is transmitted in the data communication mode, image data generated at the camera unit 926 is supplied to the image processing unit 927. The image processing unit 927 performs an encoding operation on the image data, to generate compressed image information.

The multiplexing/separating unit 928 multiplexes the compressed image information generated at the image processing unit 927 and the audio data supplied from the audio codec 923 by a predetermined method, and supplies the multiplexed data to the communication unit 922. The communication unit 922 performs a modulation operation, a frequency conversion operation, and the like on the multiplexed data, and transmits the resultant transmission signal from the antenna 921. The communication unit 922 also amplifies a signal received at the antenna 921, and performs a frequency conversion operation, a demodulation operation, and the like, to decompress the multiplexed data. This multiplexed data is supplied to the multiplexing/separating unit 928. The multiplexing/separating unit 928 divides the multiplexed data, and supplies the compressed image information to the image processing unit 927, and the audio data to the audio codec 923.

The image processing unit 927 performs a decoding operation on the compressed image information, to generate image data. This image data is supplied to the display unit 930, to display the received images. The audio codec 923 converts the audio data into an analog audio signal, and supplies the analog audio signal to the speaker 924, so that the received sound is output.

In the portable telephone device having the above structure, the image processing unit 927 has the functions of an image processing device (an image processing method) of the present invention. Accordingly, filter characteristics are changed in accordance with the size of a motion vector in an operation to encode an image to be transmitted, for example, so that decreases in compression efficiency due to deterioration in the quality of predicted images can be restrained. Also, in an operation to decode a received image, predicted image data can be generated by changing filter characteristics in the same manner as in the encoding operation. Thus, a correct decoding operation can be performed.

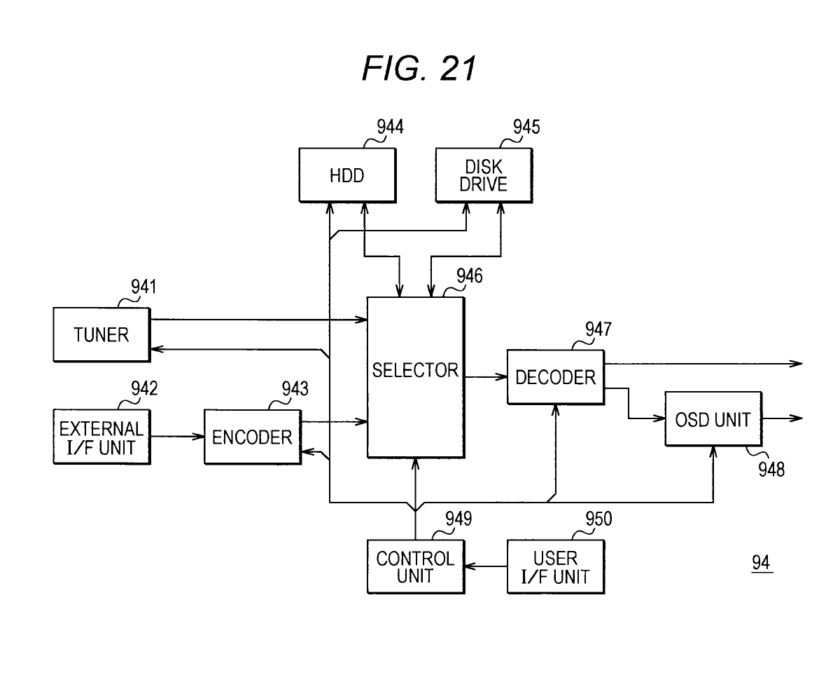

FIG. 21 schematically shows an example structure of a recording/reproducing apparatus to which the present technique is applied. The recording/reproducing apparatus 94 records the audio data and video data of a received broadcast show on a recording medium, and provides the recorded data to a user at a time according to an instruction from the user. The recording/reproducing apparatus 94 can also obtain audio data and video data from another apparatus, for example, and record the data on a recording medium. Further, the recording/reproducing apparatus 94 decodes and outputs audio data and video data recorded on a recording medium, so that a monitor device or the like can display images and outputs sound.

The recording/reproducing apparatus 94 includes a tuner 941, an external interface unit 942, an encoder 943, a HDD (Hard Disk Drive) unit 944, a disk drive 945, a selector 946, a decoder 947, an OSD (On-Screen Display) unit 948, a control unit 949, and a user interface unit 950.

The tuner 941 selects a desired channel from broadcast signals received at an antenna (not shown). The tuner 941 demodulates the received signal of the desired channel, and outputs the resultant compressed image information to the selector 946.

The external interface unit 942 is formed with at least one of an IEEE1394 interface, a network interface unit, a USB interface, a flash memory interface, and the like. The external interface unit 942 is an interface for a connection with an external device, a network, a memory card, or the like, and receives data such as video data and audio data to be recorded and the like.

In a case where video data and audio data supplied from the external interface unit 942 have not been encoded, the encoder 943 performs encoding operations by a predetermined method, and outputs the compressed image information to the selector 946.

The HDD unit 944 records content data such as videos and sound, various kinds of programs, and other data on an internal hard disk, and reads the data from the hard disk at the time of reproduction or the like.

The disk drive 945 performs signal recording and reproduction on a mounted optical disk. The optical disk may be a DVD disk (such as a DVD-Video, a DVD-RAM, a DVD-R, a DVD-RW, a DVD+R, or a DVD+RW) or a Blu-ray disc, for example.

The selector 946 selects a stream from the tuner 941 or the encoder 943 at the time of video and audio recording, and supplies the stream to either the HDD unit 944 or the disk drive 945. The selector 946 also supplies a stream output from the HDD unit 944 or the disk drive 945 to the decoder 947 at the time of video and audio reproduction.

The decoder 947 performs a decoding operation on the stream. The decoder 947 supplies the video data generated by performing the decoding to the OSD unit 948. The decoder 947 also outputs the audio data generated by performing the decoding.

The OSD unit 948 also generates video data for displaying a menu screen or the like for item selection, and superimposes the video data on video data output from the decoder 947.

The user interface unit 950 is connected to the control unit 949. The user interface unit 950 is formed with operation switches, a remote control signal reception unit, and the like, and supplies an operating signal according to a user operation to the control unit 949.

The control unit 949 is formed with a CPU, a memory, and the like. The memory stores the program to be executed by the CPU and various kinds of data necessary for the CPU to perform operations. The program stored in the memory is read and executed by the CPU at a predetermined time such as the time of activation of the recording/reproducing apparatus 94. The CPU executes the program to control the respective components so that the recording/reproducing apparatus 94 operates in accordance with user operations.

In the recording/reproducing apparatus having the above structure, the encoder 943 has the functions of an image processing device (an image processing method) of the present invention. Accordingly, filter characteristics are changed in accordance with the size of a motion vector in an encoding operation at the time of image recording, for example, so that decreases in compression efficiency due to deterioration in the quality of predicted images can be restrained. Also, in an operation to decode a recorded image, predicted image data can be generated by changing filter characteristics in the same manner as in the encoding operation. Thus, a correct decoding operation can be performed.

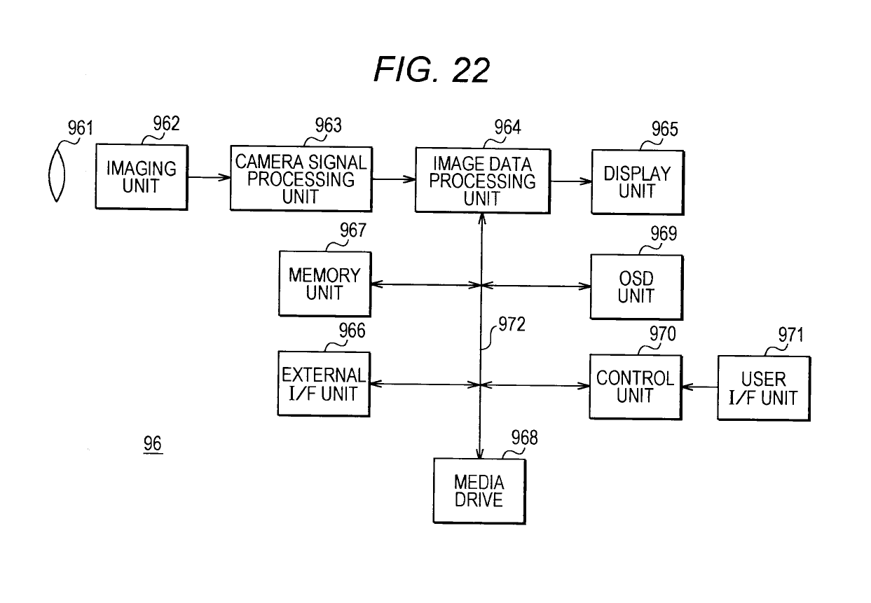

FIG. 22 schematically shows an example structure of an imaging apparatus to which the present technique is applied. An imaging apparatus 96 captures an image of an object, and causes a display unit to display the image of the object or records the image as image data on a recording medium.

The imaging apparatus 96 includes an optical block 961, an imaging unit 962, a camera signal processing unit 963, an image data processing unit 964, a display unit 965, an external interface unit 966, a memory unit 967, a media drive 968, an OSD unit 969, and a control unit 970. A user interface unit 971 is connected to the control unit 970. Further, the image data processing unit 964, the external interface unit 966, the memory unit 967, the media drive 968, the OSD unit 969, the control unit 970, and the like are connected via a bus 972.

The optical block 961 is formed with a focus lens, a diaphragm, and the like. The optical block 961 forms an optical image of an object on the imaging surface of the imaging unit 962. Formed with a CCD or a CMOS image sensor, the imaging unit 962 generates an electrical signal in accordance with the optical image through a photoelectric conversion, and supplies the electrical signal to the camera signal processing unit 963.

The camera signal processing unit 963 performs various kinds of camera signal processing such as a knee correction, a gamma correction, and a color correction on the electrical signal supplied from the imaging unit 962. The camera signal processing unit 963 supplies the image data subjected to the camera signal processing to the image data processing unit 964.

The image data processing unit 964 performs an encoding operation on the image data supplied from the camera signal processing unit 963. The image data processing unit 964 supplies the compressed image information generated by performing the encoding operation to the external interface unit 966 and the media drive 968. The image data processing unit 964 also performs a decoding operation on compressed image information supplied from the external interface unit 966 and the media drive 968. The image data processing unit 964 supplies the image data generated by performing the decoding operation to the display unit 965. The image data processing unit 964 also performs an operation to supply the image data supplied from the camera signal processing unit 963 to the display unit 965, or superimposes display data obtained from the OSD unit 969 on the image data and supplies the image data to the display unit 965.

The OSD unit 969 generates a menu screen formed with symbols, characters, or figures, or display data such as icons, and outputs such data to the image data processing unit 964.

The external interface unit 966 is formed with a USB input/output terminal and the like, for example, and is connected to a printer when image printing is performed. A drive is also connected to the external interface unit 966 where necessary, and a removable medium such as a magnetic disk or an optical disk is mounted on the drive as appropriate. A program read from such a removable medium is installed where necessary. Further, the external interface unit 966 includes a network interface connected to a predetermined network such as a LAN or the internet. The control unit 970 reads compressed image information from the memory unit 967 in accordance with an instruction from the user interface unit 971, for example, and can supply the compressed image information from the external interface unit 966 to another apparatus connected thereto via a network. The control unit 970 can also obtain, via the external interface unit 966, compressed image information or image data supplied from another apparatus via a network, and supply the compressed image information or image data to the image data processing unit 964.

A recording medium to be driven by the media drive 968 may be a readable/rewritable removable medium such as a magnetic disk, a magnetooptical disk, an optical disk, or a semiconductor memory. The recording medium may be any type of removable medium, and may be a tape device, a disk, or a memory card. The recording medium may of course be a non-contact IC card or the like.

Alternatively, the media drive 968 and a recording medium may be integrated, and may be formed with an immobile storage medium such as an internal hard disk drive or a SSD (Solid State Drive).

The control unit 970 is formed with a CPU, a memory, and the like. The memory stores the program to be executed by the CPU, various kinds of data necessary for the CPU to perform operations, and the like. The program stored in the memory is read and executed by the CPU at a predetermined time such as the time of activation of the imaging apparatus 96. The CPU executes the program to control the respective components so that the imaging apparatus 96 operates in accordance with user operations.

In the imaging apparatus having the above structure, the image data processing unit 964 has the functions of an image processing device (an image processing method) of the present invention. Accordingly, filter characteristics are changed in accordance with the size of a motion vector in an encoding operation performed when a captured image is recorded in the memory unit 967 or a recording medium or the like. Thus, decreases in compression efficiency due to deterioration in the quality of predicted images can be restrained. Also, in an operation to decode a recorded image, predicted image data can be generated by changing filter characteristics in the same manner as in the encoding operation. Thus, a correct decoding operation can be performed.

Further, the present technique should not be interpreted to be limited to the above described embodiments. The above described embodiments disclose the present technique through examples, and it should be obvious that those skilled in the art can modify or replace those embodiments with other embodiments without departing from the scope of the technique. That is, the claims should be taken into account in understanding the subject matter of the technique.

### INDUSTRIAL APPLICABILITY

With an image processing device and an image processing method of this technique, image data with fractional pixel precision of reference image data of a current block is determined by an interpolation filtering unit. The filter characteristics of the interpolation filtering unit are changed in accordance with the size of the motion vector of the current block. Further, based on the motion vector, motion compensation is performed by using the image data determined by the interpolation filtering unit, and predicted image data is generated. Accordingly, when the reference image data contains a large amount of high-pass components, or when motion size and motion blurring are small, for example, the filter characteristics are changed so as not to perform any filtering operation, and decreases in compression coefficient due to deterioration in the quality of predicted images can be restrained. In view of the above, this technique is suitable for image encoding devices, image decoding devices, and the like, which are used when compressed image information (bit streams) obtained by performing encoding on each block is transmitted and received via a network medium such as satellite broadcasting, cable television broadcasting, the Internet, or a portable telephone, or is processed on a storage medium such as an optical or magnetic disk or a flash memory.

### REFERENCE SIGNS LIST

10 . . . Image encoding device 11 . . . A/D converter 12, 57 . . . Screen rearrangement buffer 13 . . . Subtraction unit 14 . . . Orthogonal transform unit 15 . . . Quantization unit 16 . . . Lossless quantization unit 17, 51 . . . Accumulation buffer 18 . . . Rate control unit 21, 53 . . . Inverse quantization unit 22, 54 . . . Inverse orthogonal transform unit 23, 55 . . . Addition unit 24, 56 . . . Deblocking filter 26, 61 . . . Frame memory 31, 71 . . . Intra prediction unit 32 . . . Motion prediction/compensation unit 33 . . . Predicted image/optimum mode selection unit 50 . . . Image decoding device 52 . . . Lossless decoding unit 58 . . . D/A converter 62, 73 . . . Selector 72 . . . Motion compensation unit 80 . . . Computer device 90 . . . Television apparatus 92 . . . Portable telephone device 94 . . . Recording/reproducing apparatus 96 . . . Imaging apparatus 321 . . . Motion detection unit 322 . . . Mode determination unit 323, 722 . . . Motion compensation processing unit 3231, 7221 . . . Compensation control unit 3231a . . . Threshold value setting unit 3231b . . . Threshold value determination unit 3232, 7222 . . . Coefficient table 3233, 7223 . . . Filtering unit 324, 723 . . . Motion vector buffer 721 . . . Motion vector combining unit

1. An image processing device comprising:
an interpolation filtering unit configured to determine image data with fractional pixel precision of reference image data of a current block;
a filter control unit configured to change filter characteristics of the interpolation filtering unit in accordance with a size of a motion vector of the current block; and
a motion compensation processing unit configured to perform motion compensation by using the image data determined by the interpolation filtering unit, and generate predicted image data based on the motion vector.

2. The image processing device according to claim 1, wherein the filter control unit makes the filter characteristics differ between when the size of the motion vector is larger than a predetermined threshold value and when the size of the motion vector is equal to or smaller than the threshold value.

3. The image processing device according to claim 2, wherein the filter control unit sets characteristics for removing noise from the reference image data when the motion vector has integer pixel precision and the size of the motion vector is larger than the threshold value, and sets characteristics for not performing a filtering operation when the size of the motion vector is equal to or smaller than the threshold value.

4. The image processing device according to claim 2, wherein the filter control unit changes the threshold value in accordance with a distance in a temporal direction between a frame for generating the predicted image data and a frame of reference image data to be used in the motion compensation.

5. The image processing device according to claim 4, wherein the filter control unit makes the threshold value larger as the distance becomes longer.

6. The image processing device according to claim 2, wherein the filter control unit makes the threshold value zero.

7. The image processing device according to claim 2, wherein the filter control unit uses a threshold value obtained from the compressed image information or a threshold value generated based on threshold value generation information obtained from the compressed image information.

8. An image processing method comprising:
an interpolation filtering step of determining image data with fractional pixel precision of reference image data of a current block;
a filter controlling step of changing filter characteristics of the interpolation filtering step in accordance with a size of a motion vector of the current block; and
a motion compensation processing step of performing motion compensation by using the image data determined in the interpolation filtering step, and generating predicted image data based on the motion vector.
